(19) United States
(12) Patent Application Publication
(10) Pub. No.: US 2011/0208637 A1
(43) Pub. Date: Aug. 25, 2011

(54) POWER TRADE SERVER, GREEN MARKET MANAGEMENT SERVER, TRADING MANAGEMENT METHOD, AND GREEN TRADING MANAGEMENT METHOD

(76) Inventors: Yoshihiro WAKITA, Tokyo (JP); Jun Nakano, Tokyo (JP); Masaru Kuramoto, Kanagawa (JP); Yutaka Imai, Tokyo (JP)

(21) Appl. No.: 13/030,117

(22) Filed: Feb. 17, 2011

(30) Foreign Application Priority Data
Feb. 25, 2010 (JP) P2010-040463

(51) Int. Cl. G06Q 40/00

(52) U.S. Cl. 705/37

(57) ABSTRACT

There is provided a power trade server comprising a first certificate acquisition unit obtaining a first certificate certifying a storage amount of a first device for charging electricity a first user owns, from the first user eager to buy electricity, a second certificate acquisition unit obtaining a second certificate certifying a space amount of a second device for charging electricity a second user owns, from the second user eager to sell electricity, a power selling limitation unit limiting an electricity amount the first user can sell up to the storage amount of the first device for charging electricity based on the first certificate obtained by the first certificate acquisition unit, and a power purchase limitation unit limiting an electricity amount the second user can sell up to the space amount of the second device for charging electricity based on the second certificate obtained by the second certificate acquisition unit.

### BACKGROUND OF THE INVENTION

1. Field of the Invention

The present invention relates to a power trade server, a green market management server, a trading management method, and a green trading management method.

2. Description of the Related Art

The global environment has been worsening seriously in recent years, and each of countries has been taking environmental measures. Under such circumstances, a power generation method using renewable energy, such as solar power, wind power, geothermal power (hereinafter, referred to as the renewable energy generation method), and a power generation method using environmentally friendly resources, such as biomass power, fuel cell, and the like (hereinafter, referred to as the environmentally friendly energy generation method) are drawing a great deal of attention. At present, a thermal power generation method using fossil fuels, such as oil, coal, and the like, nuclear power generation method using atomic power, and hydroelectric power generation method using flowing water are mainly used.

The nuclear power generation method is an environmentally friendly power generation method, but has difficulties and risks in the safety of managing atomic fuels. The hydroelectric power generation method is also environmentally friendly, however, only areas with geographical conditions for constructing dams, or the like, can utilize this method. The thermal power generation method are facing problems such as the drain of fossil fuels, emissions of CO₂, NOₓ, and the like, generated from burning fossil fuels. In the light of circumstances, methods for replacing most of electric power produced by the thermal power generation method with the renewable energy generation method or the environmentally friendly energy generation method are under discussion.

In recent years, individuals of electric power consumers are becoming more conscious of global environmental issues, and there is a movement to apply the renewable energy generation method or a power generator of environmentally friendly energy generation method (hereinafter, referred to as a green power generation apparatus) in household. Further, in order to resolve problems of instability in supply power that is a weak point of the renewable energy generation method, there is also a movement to apply an electric storage apparatus in household along with the power generator of renewable energy generation method. In other words, individuals of electric power consumers are getting to apply the green power generation apparatus or the electric storage apparatus in household in a rapid pace. In the near future, individuals of electric power consumers will generate electric power in their household, and cover own consumption with the electric power generated by themselves.

At present, electric power companies are buying surplus electricity that those individuals of electric power consumers could not consume themselves, out of the electricity generated by those individuals of electric power consumers. However, for the electric power companies, the electricity to be bought from the individuals of electric power consumers is instable power source unpredictable of its capacity and its timing of supply. Such electricity is not attractive for the electric power companies, so prices of the electricity selling to the electric power companies from the individuals of electric power consumers are tend to be low. The amount of electricity produced by each of the electric power consumers is extremely small comparing to the capacity currently trading in the power trading market, therefore, individuals of electric power consumers may be impossible to buy the electricity in the power trading market in the preset situation.

Further, the existing power trading market is created by limited players. In fact, it may be practically impossible for individuals of electric power consumers to trade in the power trading market. Regarding the electricity trading, Japanese Unexamined Patent Application Publication No. 2008-225755 discloses a method for predicting precisely the amount of electricity to sell and to buy based on past trading history in the power trading market. Regarding the structure of the current electricity trading, information distributed from the Japan Electric Power Exchange, the Chicago Mercantile Exchange (CME), or the like, would be useful.

### SUMMARY OF THE INVENTION

Under the circumstances, it is expected a structure that effectively utilizes the electricity generated by individuals of electric power consumers using green power generation apparatuses (hereinafter, referred to as green electricity). It is also expected that a power trading market in a small size which individuals of electric power consumers can join will be realized. For example, a power community, where each of electric power consumers can accommodate each other with electricity through trading their surplus electricity, is desired for each local area. In order to realize this, however, there are many questions to be cleared, such as how each individual of electric power consumers can be identified, how arbitrage price of electric power should be decided, and the like. Building of a structure for resolving these issues is also expected.

In light of the foregoing, it is desirable to provide a power trade server, a green market management server, a trading management method, and a green trading management method, which are novel and improved, and which are capable of building a structure to certificate for green power.

According to an embodiment of the present invention, there is provided a power trade server including a first certificate acquisition unit for obtaining a first certificate from a first user who wants to sell electricity, the first certificate being for certifying an amount of stored electricity of a first device for charging electricity owned by the first user, a second certificate acquisition unit for obtaining a second certificate from a second user who wants to buy electricity, the second certificate being for certifying an amount of space of a second device for charging electricity owned by the second user, a power selling limitation unit for limiting an amount of electricity the first user can sell up to the amount of stored electricity of the first device for charging electricity based on the first certificate obtained by the first certificate acquisition unit, and a power purchase limitation unit for limiting an amount of electricity the second user can buy up to the amount of space of the second device for charging electricity based on the second certificate obtained by the second certificate acquisition unit.

When the first user owns a device for generating electricity, the first certificate acquisition unit may be configured to obtain a first certificate for certifying the amount of stored electricity of the first device for charging electricity, and an expected electric-generation capacity which is predicted from an actual electric-generation capacity by the device for generating electricity. In this case, the power selling limitation unit limits the amount of electricity the first user can sell up to a first total value of the amount of stored electricity of the first device for charging electricity and the expected electric-generation capacity of the device for generating electricity based on the first certificate obtained by the first certificate acquisition unit.

When the first user places a sell order to sell the first total value of the amount of electricity while being unable to supply the first total value of the amount of electricity at the time of power supply, the power selling limitation unit may be configured to allow the first user to repurchase the amount of electricity at a surcharge price.

When the second user manages history of an amount of electricity consumed by the second device for charging electricity, the second certificate acquisition unit may be configured to obtain a second certificate for certifying the amount of space of the second device for charging electricity owned by the second user, and an expected amount of consumption predicted by an actual consumption of the amount of electricity consumed by the second device for charging electricity. In this case, the power purchase limitation unit limits the amount of electricity the second user can buy up to a second total value of the amount of space and the expected amount of consumption of the second device for charging electricity based on the second certificate obtained by the second certificate acquisition unit.

When the second user places a buy order to purchase the second total value of the amount of electricity while being unable to receive the second total value of the amount of electricity at the time of power supply, the power purchase limitation unit may be configured to allow the second user to sell back the amount of electricity at a surcharge price.

The power trade server may further include a green certificate acquisition unit for obtaining a green certificate for certifying that electricity to be traded is green power generated by renewable energy or environmentally friendly resources, and a green price setting unit for setting a buying price of the green power that is more expensive than a general buying price of electricity the first user wants to buy when the green certificate acquisition unit obtains a green certificate of the electricity the first user wants to buy.

The power trade server may further include an order reception unit for receiving sell orders and buy orders of electricity, a market price decision unit for determining a selling price and a buying price in a power trading market depending on a balance of supply and demand based on an amount of the sell orders and the buy orders that the order reception unit has received, and a supply control unit for supplying an amount of electricity ordered by the first user from the first device for charging electricity to a certain electric storage apparatus when the first user has closed the selling trade, and for supplying the amount of electricity ordered by the second user from the certain electric storage apparatus to the second device for charging electricity when the second user has closed the buying trade.

The order reception unit may limit reception of orders not to receive orders successively from the same user in a certain period of time.

When the first user has closed the selling trade, the supply control unit may be configured to supply an amount of electricity ordered by the first user from the first device for charging electricity to a certain electric storage apparatus after a certain period of time has elapsed since the closing of the trade, and when the second user has closed the buying trade, the supply control unit may be configured to supply an amount of electricity ordered by the second user from the certain electric storage apparatus to the second device for charging electricity after a certain period of time has elapsed since the closing of the trade.

The power trade server may further include a local market price collection unit for separating a small trading market into small communities where power is actually to be traded therebetween, and for obtaining a selling price and a buying price in each small trading market from a plurality of the small trading market separated into the small communities. In this case, the market price decision unit decides a selling price and a buying price in a large-scale trading market in a large community, that has been set larger than the small communities, based the selling price and the buying price in the plurality of the small trading market obtained by the local market price collection unit.

The power trade server may further include a market price forecasting unit for forecasting changes in future buying prices and selling prices based on at least one or a plurality of elements selected from changes in buying prices and selling prices decided by the market price decision unit in the past, changes in amount of selling orders and buying orders received by the order reception unit in the past, information on occurrence factor of renewable energy in the past or at present, and prediction information on occurrence factor of renewable energy in future.

According to another embodiment of the present invention, there is provided a green market management server, including an order reception unit for receiving a sell order and a buy order regarding a green certificate issued for power that is generated by renewable energy or environmentally friendly resources, the green certificate being for certifying an electric-generation capacity of the power and for certifying that the power is based on renewable energy or environmentally friendly resources, and a market price decision unit for determining a selling price and a buying price of the green certificate depending on balance of supply and demand based on an amount of the sell orders and the buy orders that the order reception unit has received.

According to another embodiment of the present invention, there is provided a trading management method wherein a power trade server includes the steps of obtaining a first certificate from a first user who wants to buy electricity, the first certificate being for certifying an amount of stored electricity of a first device for charging electricity owned by the first user, and obtaining a second certificate from a second user who wants to sell electricity, the second certificate being for certifying an amount of space of a second device for charging electricity owned by the second user, limiting an amount of electricity the first user can sell up to the amount of stored electricity of the first device for charging electricity based on the first certificate obtained by the step of obtaining the first certificate, and limiting an amount of electricity the second user can buy up to the amount of space of the second device for charging electricity based on the second certificate obtained by the step of obtaining the second certificate.

According to another embodiment of the present invention, there is provided a green trading management method including the steps of receiving a sell order and a buy order regarding a green certificate issued for power that is generated by renewable energy or environmentally friendly resources, the green certificate being for certifying an electric-generation capacity of the power and for certifying that the power is based on renewable energy or environmentally friendly resources, and determining a selling price and a buying price of the green certificate depending on a balance of supply and demand based on an amount of the sell orders and the buy orders received in the step of receiving.

According to the embodiments of the present invention described above, it is possible to build a structure to certificate for green power.

### BRIEF DESCRIPTION OF THE DRAWINGS

FIG. 1 is an explanatory diagram for illustrating a configuration of a green power generation system according to the first embodiment of the present invention;

FIG. 2 is an explanatory diagram for illustrating a functional configuration of a green power generation apparatus according to the present embodiment;

FIG. 3 is an explanatory diagram for illustrating a functional configuration of a certificate of electric-generation issuance unit according to the present embodiment;

FIG. 4 is an explanatory diagram for illustrating a functional configuration of an electric storage apparatus according to the present embodiment;

FIG. 5 is an explanatory diagram for illustrating a functional configuration of a certificate of electric-storage issuance unit according to the present embodiment;

FIG. 6 is an explanatory diagram for illustrating a functional configuration of an interface apparatus according to the present embodiment;

FIG. 7 is an explanatory diagram for illustrating a configuration of a green power generation system according to the second embodiment of the present invention;

FIG. 8 is an explanatory diagram for illustrating a functional configuration of an electric storage apparatus according to the present embodiment;

FIG. 9 is an explanatory diagram for illustrating a functional configuration of a certificate of remaining issuance unit according to the present embodiment;

FIG. 10 is an explanatory diagram for illustrating a functional configuration of a certificate of space issuance unit according to the present embodiment;

FIG. 11 is an explanatory diagram for illustrating a functional configuration of an interface apparatus according to the present embodiment;

FIG. 12 is an explanatory diagram for illustrating a functional configuration of a certificate of consumption issuance unit according to the present embodiment;

FIG. 13 is an explanatory diagram for illustrating a functional configuration of a power trade server according to the present embodiment;

FIG. 14 is an explanatory diagram for illustrating a configuration of a green power generation system according to the third embodiment of the present invention;

FIG. 15 is an explanatory diagram for illustrating a functional configuration of a green power generation apparatus according to the present embodiment;

FIG. 16 is an explanatory diagram for illustrating a functional configuration of a certificate of electric-generation issuance unit according to the present embodiment;

FIG. 17 is an explanatory diagram for illustrating a functional configuration of an electric storage apparatus according to the present embodiment;

FIG. 18 is an explanatory diagram for illustrating a functional configuration of an interface apparatus according to the present embodiment;

FIG. 19 is an explanatory diagram for illustrating a flow of operation for transmitting electric power according to the present embodiment;

FIG. 20 is an explanatory diagram for illustrating a flow of operation for transmitting electric power according to the present embodiment;

FIG. 21 is an explanatory diagram for illustrating an example of a hardware configuration capable of realizing functions of various types of certificate issuance unit, an interface apparatus, a mobile device, a power trade server, or the like.

### DETAILED DESCRIPTION OF THE EMBODIMENT(S)

Hereinafter, preferred embodiments of the present invention will be described in detail with reference to the appended drawings. Note that, in this specification and the appended drawings, structural elements that have substantially the same function and structure are denoted with the same reference numerals, and repeated explanation of these structural elements is omitted.

(Flow of Explanation)

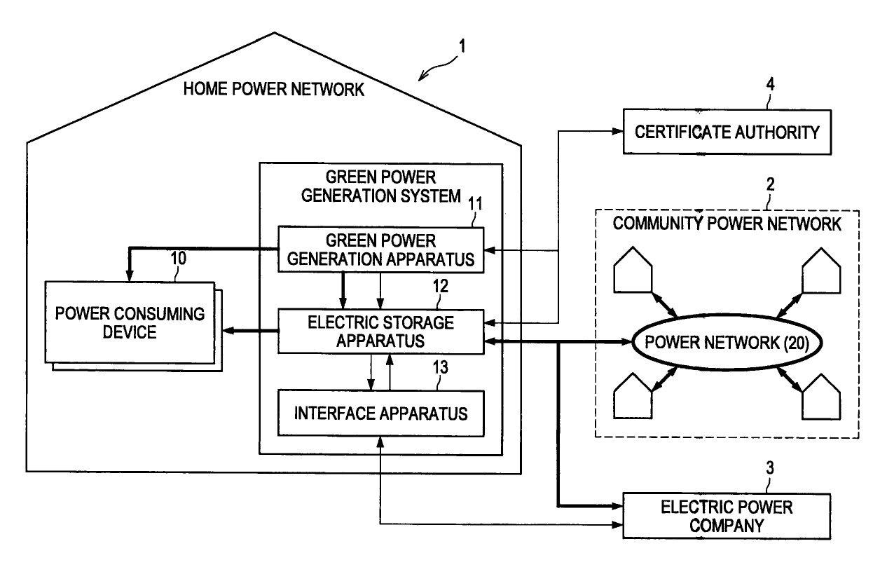

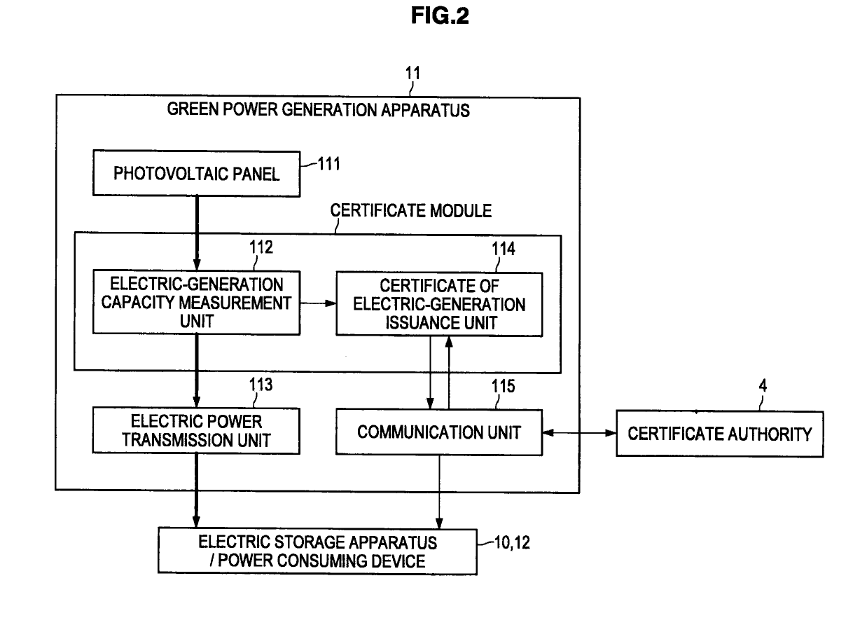

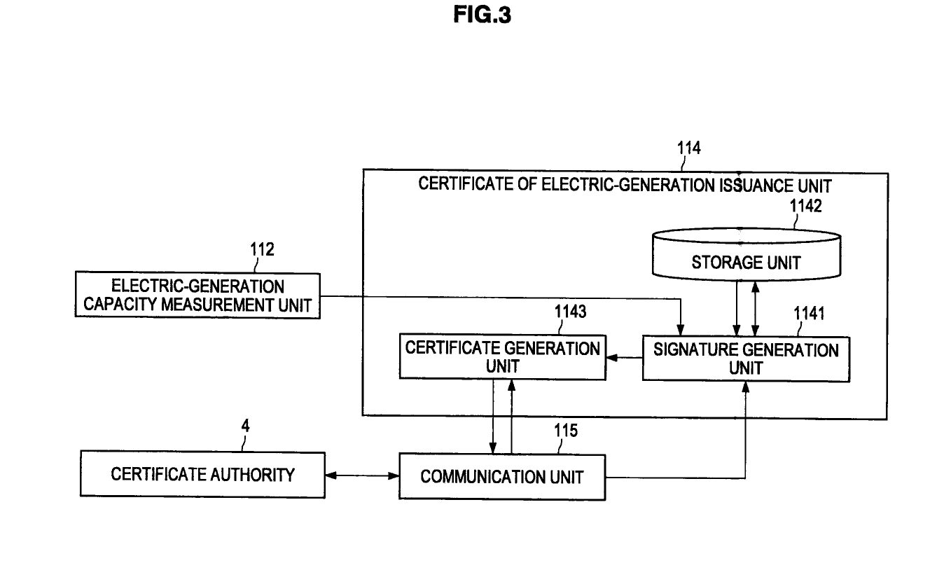

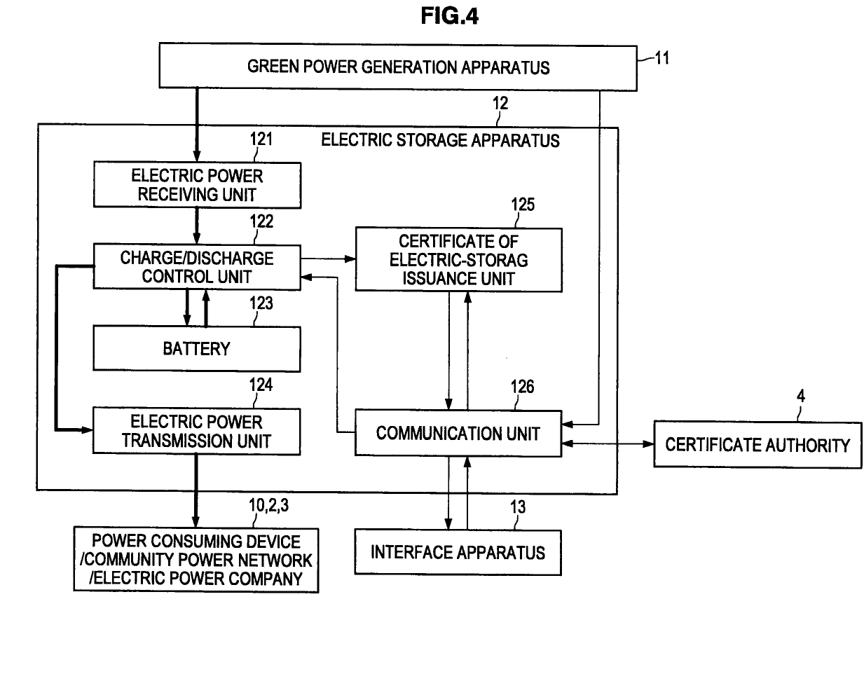

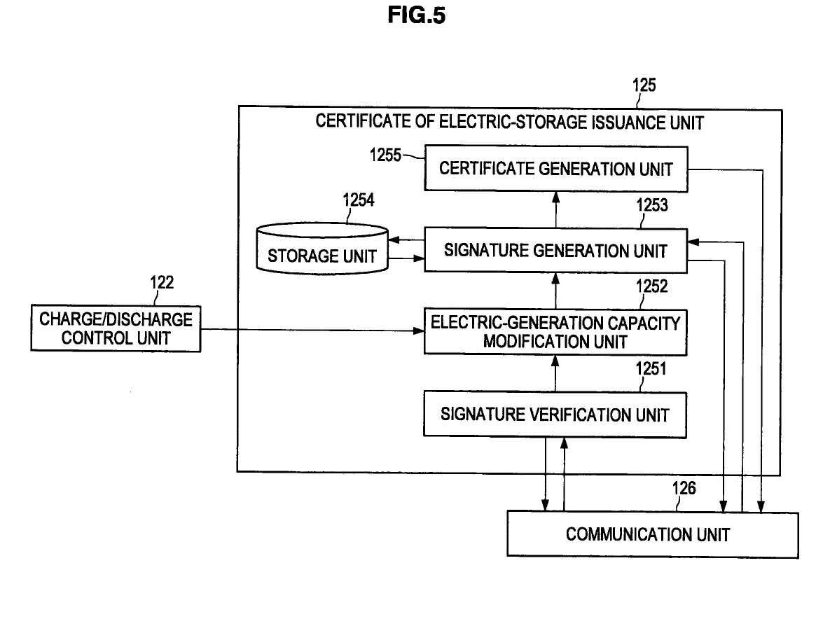

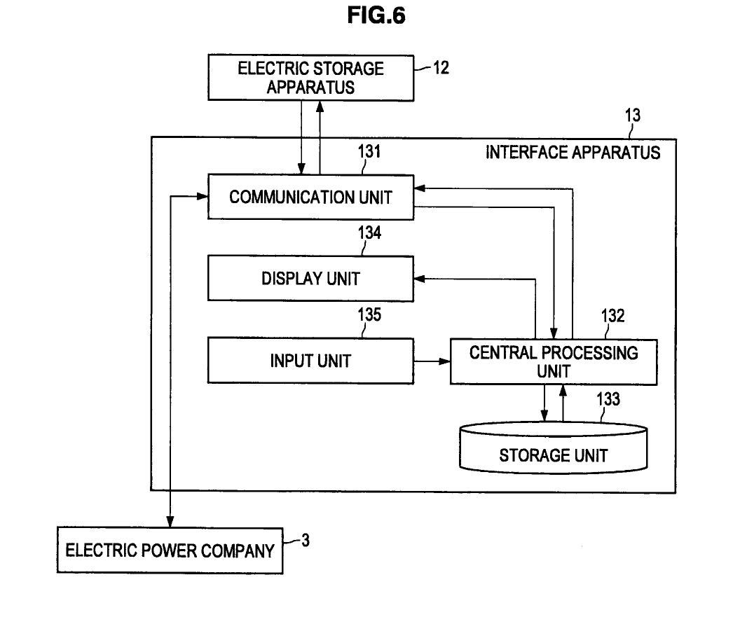

The flow of explanation described below regarding the embodiment of the present invention will be explained in brief. At first, an explanation will be given on a configuration of a home power network 1 according to the first embodiment of the present invention with reference to FIG. 1. Then, with reference to FIG. 2 and FIG. 3, an explanation will be given on a green power generation apparatus 11 according to the present embodiment. With reference to FIG. 4, and FIG. 5, an explanation will be given on a configuration of an electric storage apparatus 12 according to the present embodiment. With reference FIG. 6, an explanation will be given on a configuration of an interface apparatus 13 according to the present embodiment.

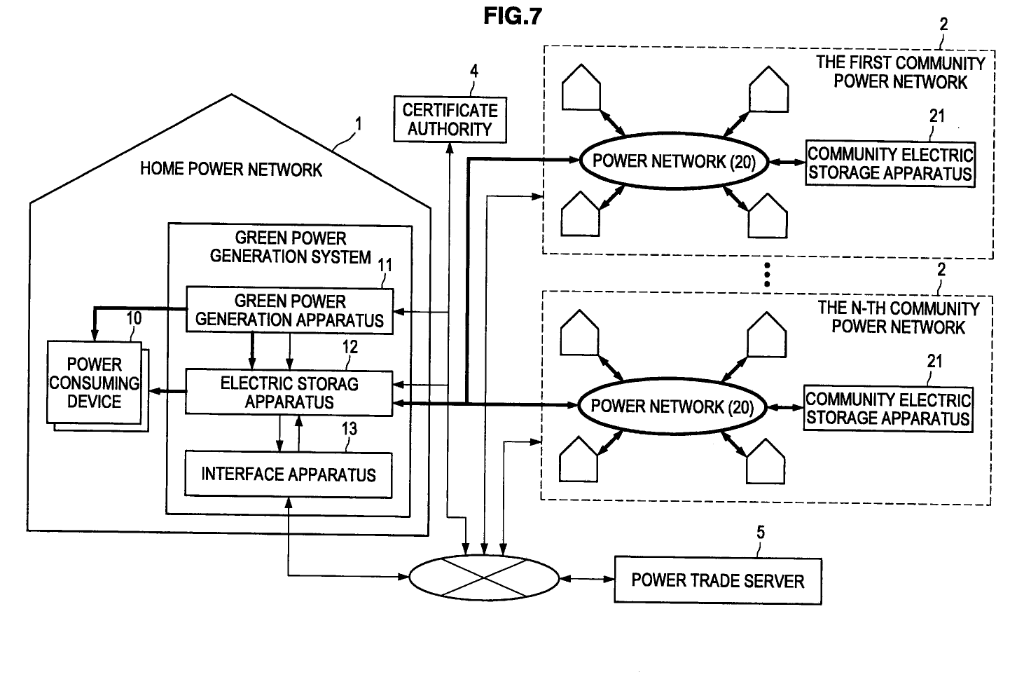

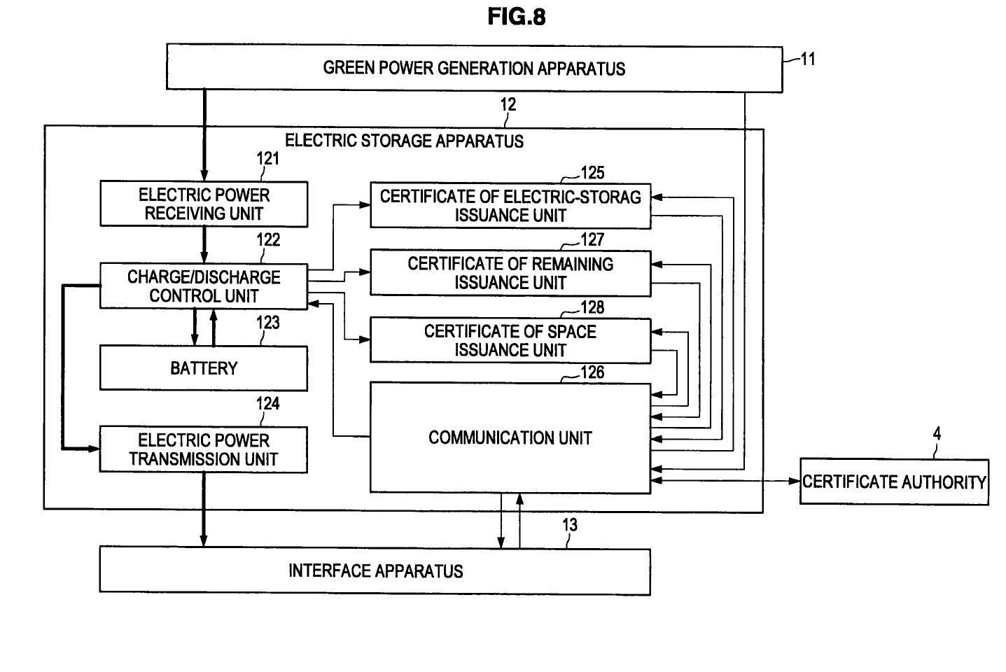

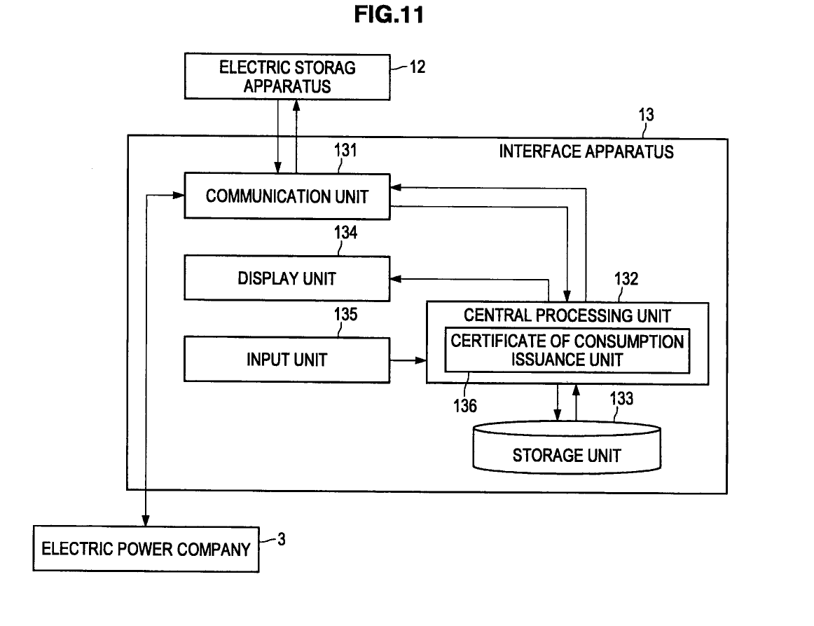

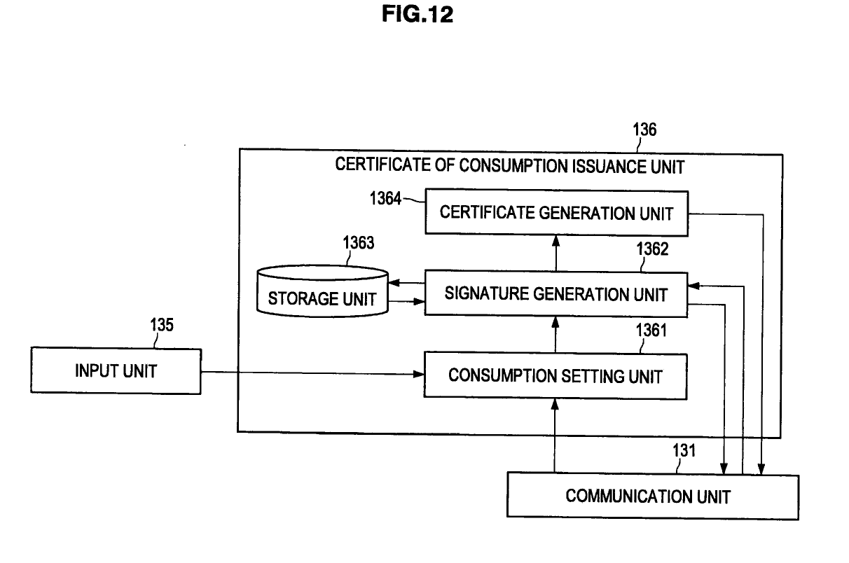

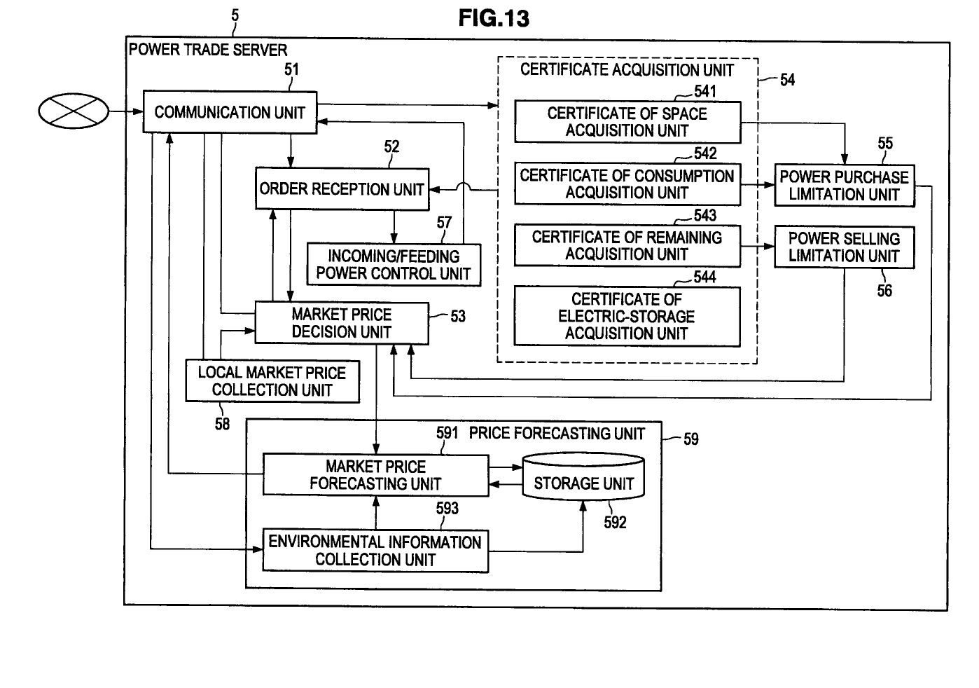

Next, with reference to FIG. 7, an explanation will be given on a configuration of a power trade system according to the second embodiment of the present invention. With reference to FIG. 8 to FIG. 10, an explanation will be given on a configuration of an electric storage apparatus 12 according to the present embodiment. Next, with reference to FIG. 11 and FIG. 12, an explanation will be given on a configuration of an interface apparatus 13. Then, with reference to FIG. 13, an explanation will be given on a power trade server 5 according to the present embodiment.

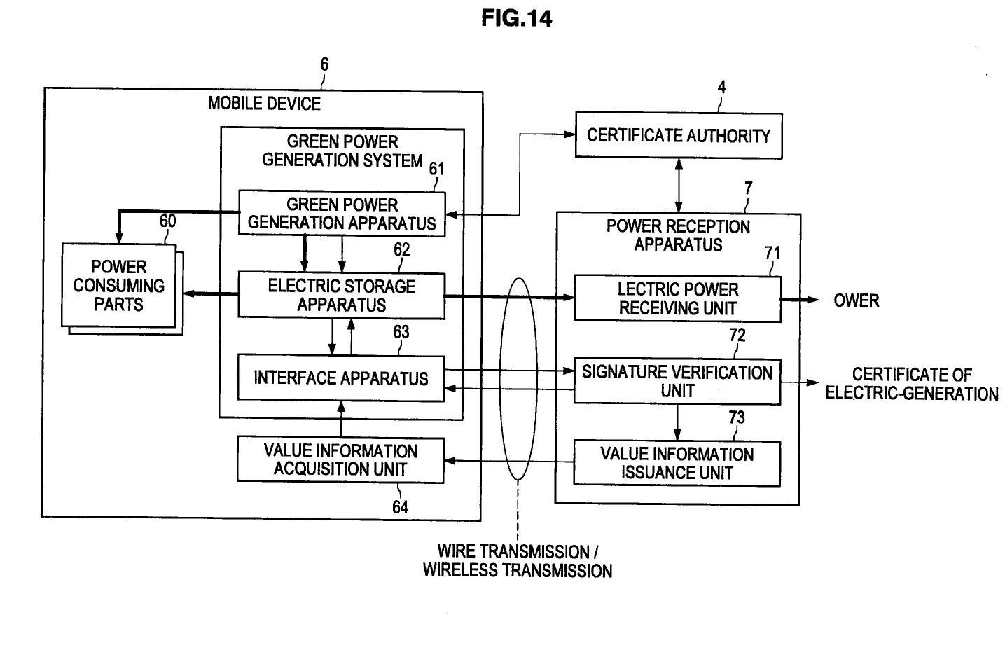

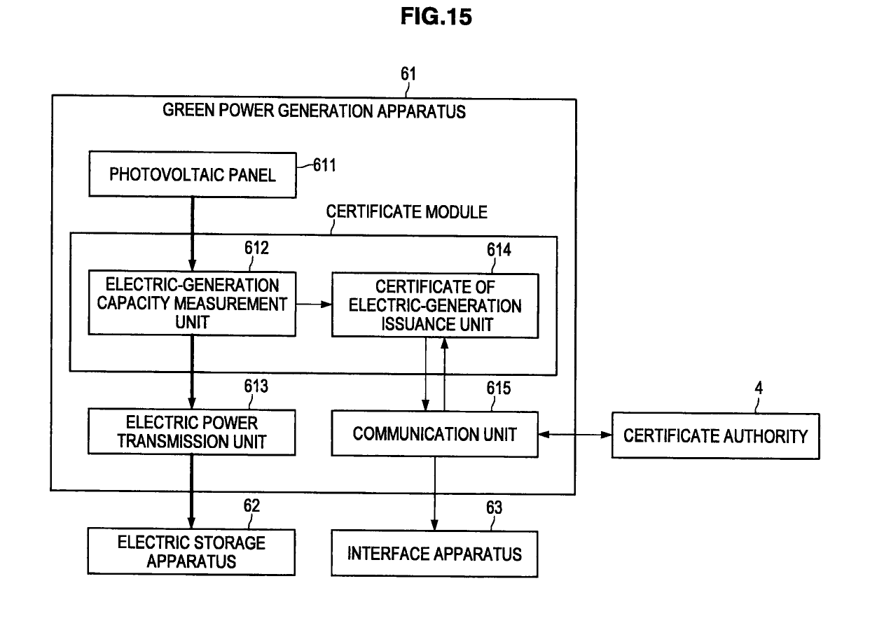

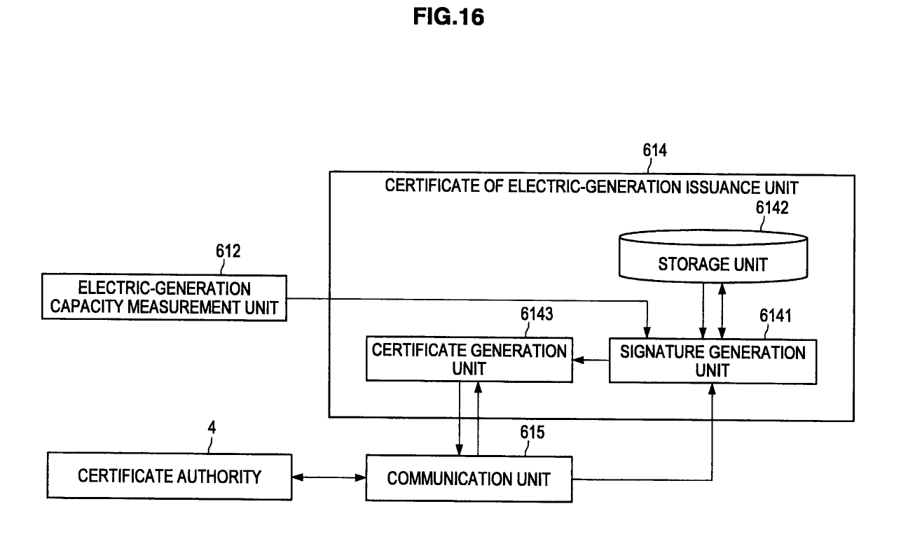

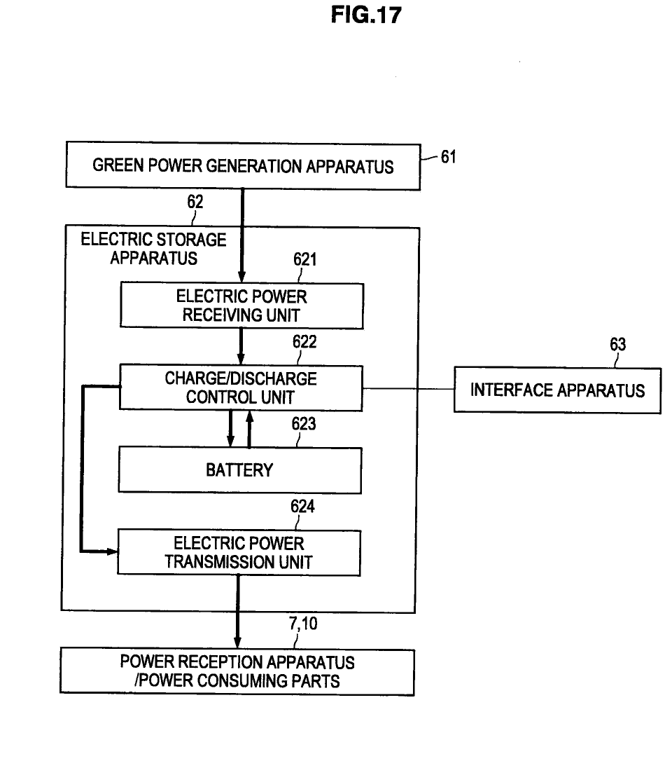

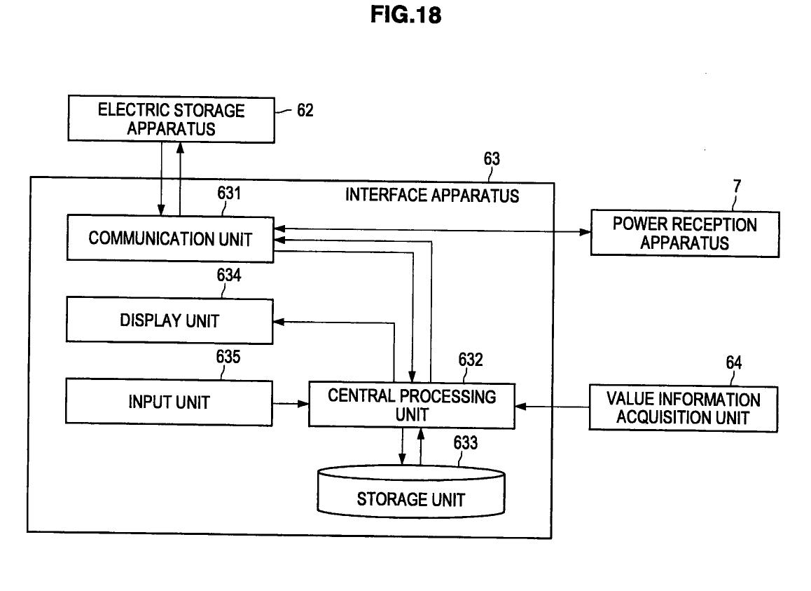

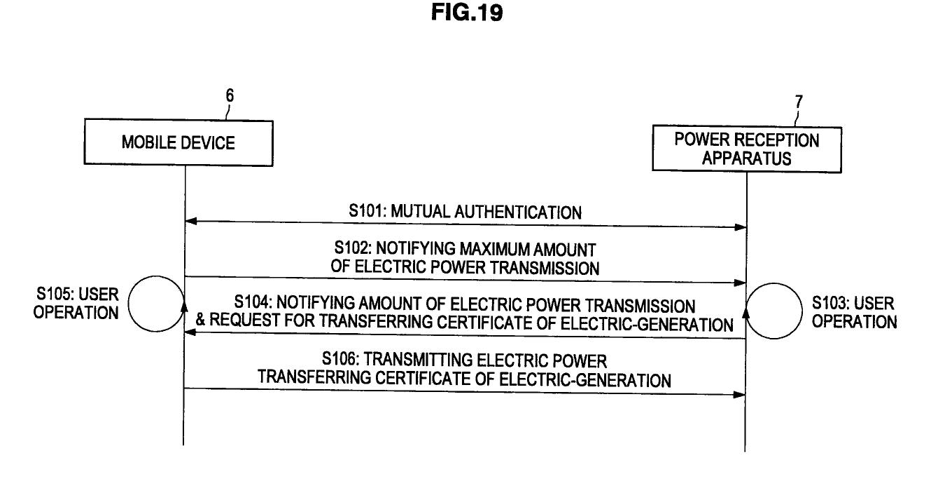

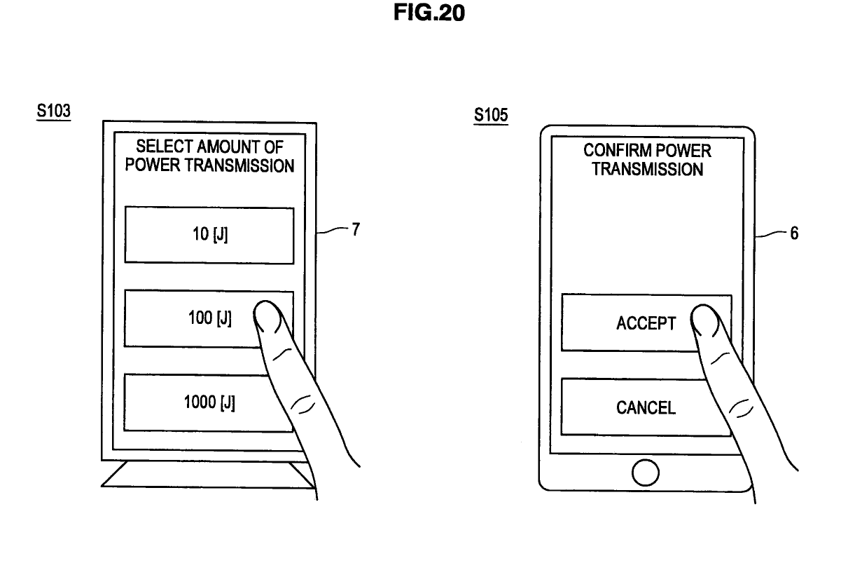

With reference to FIG. 14, an explanation will be given on configurations of a mobile device 6 and a power reception apparatus 7 according to the third embodiment of the present invention. With reference to FIG. 15 and FIG. 16, an explanation will be given on a green power generation apparatus 61 according to the embodiment. With reference to FIG. 17, an explanation will be given on a configuration of an electric storage apparatus 62. With reference to FIG. 18, an explanation will be given on a configuration of an interface apparatus 63. Next, with reference to FIG. 19 and FIG. 20, an explanation will be given on an operational method for transmitting electric power according to the embodiment.

Subsequently, an explanation will be given on an example of a hardware configuration capable of realizing functions of an interface apparatus, a mobile device, a power trade server, or the like. Lastly, technical philosophy of the embodiment will be overviewed and a brief explanation will be given on function effects derived from its technical philosophy.

### DESCRIPTION ITEMS

1: First Embodiment (Issuing a Green Certificate)
1-1: Configuration of Home Power Network 1
1-2: Configuration of Green Power Generation Apparatus 11
1-3: Configuration of Electric Storage Apparatus 12
1-4: Configuration of Interface Apparatus 13

2: Second Embodiment (STRUCTURE OF POWER TRADING MARKET FOR INDIVIDUAL CONSUMER)
2-1: Configuration of Power Trade System
2-2: Configuration of Electric Storage Apparatus 12
2-3: Configuration of Interface Apparatus 13
2-4: Configuration of Power Trade Server 5

3: Third Embodiment (Services based on a Green Certificate)
3-1: Configuration of Mobile Device 6
3-2: Configuration of Green Power Generation Apparatus 61
3-3: Configuration of Electric Storage Apparatus 62
3-4: Configuration of Interface Apparatus 63
3-5: Operation for Transmitting Electric Power

4: Example of Hardware Configuration

5: Conclusion

### 1: First Embodiment

### Issuing a Green Certificate

Hereinafter, an explanation will be given on the first embodiment of the present invention.

(1-1: Configuration of Home Power Network 1)

At first, an explanation will be given on a configuration of a home power network 1 according to the first embodiment of the present invention with reference to FIG. 1. FIG. 1 is an explanatory diagram for illustrating a configuration of a green power generation system according to the first embodiment. Note that a word of “household” will be used so that a concrete configuration can be grasped easily, and the expression of “household” means a size that an individual of electric power consumer can handle by himself.

As shown in FIG. 1, the home power network 1 includes a power consuming device 10, a green power generation apparatus 11, an electric storage apparatus 12, and an interface apparatus 13. The home power network 1 is connected to a community power network 2 and an electric power company 3 via power lines. Further, in this specification, the green power generation apparatus 11, the electric storage apparatus 12, and the interface apparatus 13 may be collectively called a green power generation apparatus.

The power consuming device 10 is a device that consumes electric power. For example, the power consuming device 10 is a home electric appliance, such as a refrigerator, a washing machine, an air conditioner, an electric fan, an electric heating appliance, a computer, a video receiver, a video recording/reproducing device, a music player, an audio recorder, a lighting equipment, an electric stove, a microwave oven, a dishwasher, a ventilating fan, a drier, an electric toothbrush, or the like.

The green power generation apparatus 11 is a method of electric power generation for generating electricity using renewable energy or environmentally friendly resources. For example, the green power generation apparatus 11 is a method of electric power for generating electricity using solar power, wind power, geothermal power, water power, atomic power, biomass fuel, hydrogen fuel, or the like. This specification, however, will describe with the photovoltaic power generation in mind for convenience.

The electric storage apparatus 12 is a method of charging electric power. The electric storage apparatus 12 is a method of charging electric power, for example, a lead-acid battery, a lithium ion secondary battery (Li-Ion battery), a sodium-sulfur battery (NaS battery), an electric double-layer capacitor, a pumped hydroelectric storage system, a superconducting flywheel, a super capacitor, or the like. This specification, however, will describe with a battery using the lithium ion secondary battery in mind for convenience.

The interface apparatus 13 is a method of interface for an electric power consumer (hereinafter, a user) to input information, or for displaying information to the user. Note that the interface apparatus 13 may be incorporated into the green power generation apparatus 11, and the electric storage apparatus 12. Moreover, the green power generation apparatus 11 and the electric storage apparatus 12 may be combined as a unit. Further, the green power generation apparatus 11, the electric storage apparatus 12, and the interface apparatus 13 may be combined as a unit.

An example shown in FIG. 1 includes the power consuming device 10 that operates upon supply of electric power directly from the green power generation apparatus 11, and the power consuming device 10 that operates upon supply of electric power charged in the electric storage apparatus 12. Generally, electricity generated using renewable energy tends to be unstable. It is preferable to utilize electric power that has been charged once in the electric storage apparatus 12 as a utilization form of the power consuming device 10. For this reason, this specification will describe with the power consuming device 10 only in mind, which operates upon supply of electricity charged in the electric storage apparatus 12.

The electricity generated by the green power generation apparatus 11 is to be stored in the electric storage apparatus 12. The electric storage apparatus 12 can also store electricity upon supply of the electricity from the electric power company 3. The electricity stored in the electric storage apparatus 12 is to be supplied to the power consuming device 10, as described above. The electricity stored in the electric storage apparatus 12 is to be supplied to the community power network 2 and the electric power company 3. For example, surplus electricity, which has not been consumed by the power consuming device 10 and has remained out of the electricity generated by the green power generation apparatus 11, is to be sold to the electric power company 3. Such surplus electricity may be supplied to the community power network 2 and may be sold to other users who form the community power network 2.

On the contrary, to buy electricity from the other user who forms the community power network 2, the electricity bought is to be stored in the electric storage apparatus 12. The community power network 2 is a kind of electric power community that is formed by connecting a plurality of the home power networks 1 to the power network 20. Note that the term of “community” herein does not necessarily mean divisions such prefectures, municipalities, or the like, but a range of object for being managed as one of the power network 20. Needless to say, the community power network 2 may be divided by prefectures, municipalities, or administrative areas managed by each of the electric power company 3, or the like. Note that the example of FIG. 1 describes that the home power network 1 whose configuration is shown in detail is outside of the community power network 2 for the sake of simplicity of the figures, however, this home power network 1 is supposed to be included into the community power network 2.

As described above, the electricity stored in the electric storage apparatus 12 will not only be consumed by the power consuming device 10 which is included in the home power network 1, but also be supplied to the electric power company 3 or the community power network 2. Moreover, the electricity bought from another home power network 1 or the electric power company 3, which form the community power network 2 is to be stored in the electric storage apparatus 12. Thus in a system assumed in the present embodiment, electricity is to be received/transmitted both in outside and inside of the home power network 1. User operations regarding such reception/transmission of electricity are performed via the interface apparatus 13. For example, an operation to buy electricity from the electric power company 3 or the other home power network 1 is performed using the interface apparatus 13.

For this reason, the interface apparatus 13 is connected to the other home power network 1 or the electric power company 3 via a communication network (not shown), and can exchange information with the other home power network 1 or the electric power company 3. The interface apparatus 13 can acquire information on the amount of stored electricity or on the amount of space, or the like, from the electric storage apparatus 12, and can display the acquired information. The interface apparatus 13 can acquire information on electric-generation capacity from the green power generation apparatus 11. Further, the interface apparatus 13 can acquire a later-described a certificate of electric-generation from the green power generation apparatus 11, and acquire a later-described a certificate of electric-storage from the electric storage apparatus 12.

The certificate of electric-generation above is a digital certificate that certifies for electricity generated by green power generation. This certificate of electric-generation is issued by the green power generation apparatus 11. The certificate of electric-storage is also a digital certificate that certifies for electricity generated by green power generation, similarly to the certificate of electric-generation. However, while the certificate of electric-generation is issued targeting the electricity output from the green power generation apparatus 11, the certificate of electric-storage is issued targeting the electricity output from the electric storage apparatus 12. In other words, the certificate of electric-storage is issued targeting electricity which has been lost through storage among total electric power generated by the green power generation.

A digital certificate includes information to be certified, a digital signature based on the information to be certified, and a public key for verification of the digital signature. It is no doubt that this public key is the one certified by a reliable certificate authority. In the example of FIG. 1, a certificate authority 4 corresponds to the certificate authority that certifies the public key. Further, the green power generation apparatus 11 and the electric storage apparatus 12 are assumed to hold in advance a secret key and a public key necessary for issuance of the digital certificate. The public key is assumed to be certified by the certificate authority 4.

As described above, the green power generation apparatus 11 holds the secret key paired with the public key that is certified by the certificate authority 4. Utilizing this secret key, the green power generation apparatus 11 issues a certificate of electric-generation that certifies information on electric-generation capacity when supplying the generated electricity to the electric storage apparatus 12. Specifically, the green power generation apparatus 11 generates a digital signature based on the information on the electric-generation capacity by utilizing the secret key, and generates a certificate of electric-generation with the addition of a digital signature to the information on the electric-generation capacity. Note that information on an area where the electricity has been generated (information that identifies the community power network 2) may be added to the certificate of electric-generation.

The certificate of electric-generation issued by the green power generation apparatus 11 is to be input into the electric storage apparatus 12. As described above, the electric storage apparatus 12 holds a secret key paired with a public key that has been certified by the certificate authority 4, and the electric storage apparatus 12 uses this secret key to issue a certificate of electric-storage. At first, the electric storage apparatus 12 acquires a public key certificate of the green power generation apparatus 11 from the certificate authority 4, and verifies a digital signature contained in the certificate of electric-generation by using a public key contained in the public key certificate.

If succeeded in verifying the digital signature, the electric storage apparatus 12 multiplies electric-generation capacity contained in information of the certificate of electric-generation by storage efficiency to calculate electric-generation capacity modified based on electricity which has been lost through storage (hereinafter, referred to as modified electric-generation capacity). Subsequently, the electric storage apparatus 12 issues a certificate of electric-storage that certifies information on the modified electric-generation capacity. Specifically, the electric storage apparatus 12 generates a digital signature based on the information on the modified electric-generation capacity by utilizing the secret key, and generates a certificate of electric-storage with the addition of a digital signature to the information on the modified electric-generation capacity. Note that information on an area where the electricity has been generated (information that identifies the community power network 2) may be added to the certificate of electric-storage.

The certificate of electric-storage issued as above is to be input into the interface apparatus 13. The interface apparatus 13 provides the certificate of electric-storage that has been input by the electric storage apparatus 12 to another home power network 1 or electric power company 3, when supplying electricity from the electric storage apparatus 12 to the other home power network 1 or the electric power company 3. By providing the certificate of electric-storage in this way, it can verify that the electricity provided from the electric storage apparatus 12 is green energy.

Thus, the green power generation system according to the present embodiment utilizes the certificate of electric-generation to provide a structure for verifying that the electricity generated by the green power generation apparatus 11 is green power. By using such structure, when there is a gap between green power price and standard power price, for example, providing a certificate of electric-storage make it possible to sell the electricity of the electric storage apparatus 12 at the green power price.

Moreover, even in a case where the electricity generated by the green power generation apparatus 11 has been consumed within the home power network 1, a certificate of electric-generation remains if nothing else. By selling the electricity bought from the electric power company 3 with the addition of the certificate of electric-generation, benefit that should be gained from generating the green power will be collected later. Providing such structure makes the monetary value of the green power generation visible, and it is expected that this would encourage the users to invest in equipments for green power generation. Moreover, if the above structure is realized, the certificate of electric-generation itself gains monetary value and the certificate of electric-generation can be securitized.

Thus, to corporealize the value of green power is extremely meaningful for the purpose of boost the user's awareness of the green power generation. If the value of green power generation would be widely-recognized, it accelerates the equipment investment for green power generation, and consequently, it will decrease the amount of emission of greenhouse gases. Building a structure to combine the value of green power and the monetary value is expected to lead to improve the world environment as a result. The overall picture of the green power generation system has been overviewed hereto. Detail configuration of the green power generation system will be described later.

The configuration of the home power network 1 according to the present embodiment has been explained as above.

(1-2: Configuration of Green Power Generation Apparatus 11)

With reference to FIG. 2 and FIG. 3, an explanation will be given on configurations of the green power generation apparatus 11 according to the present embodiment. FIG. 2 is an explanatory diagram for illustrating a functional configuration of the green power generation apparatus 11 according to the embodiment of the present invention. FIG. 3 is an explanatory diagram for illustrating a functional configuration of a certificate of electric-generation issuance unit 114 according to the embodiment of the present invention.

(Overall Configuration)

As shown in FIG. 2, the green power generation apparatus 11 includes a photovoltaic panel 111, an electric-generation capacity measurement unit 112, an electric power transmission unit 113, a certificate of electric-generation issuance unit 114, and a communication unit 115. Note that in the following description, the electric-generation capacity measurement unit 112 and the certificate of electric-generation issuance unit 114 may be collectively called a certificate module.

The photovoltaic panel 111 is a method of generating power for converting the energy of solar light into electricity. The photovoltaic panel 111 utilizes, for example, silicon solar cells or dye-sensitised solar cells, or the like. The electricity generated by the photovoltaic panel 111 is to be input into the electric-generation capacity measurement unit 112. The electric-generation capacity measurement unit 112 measures the electric-generation capacity of the photovoltaic panel 111. Information on the electric-generation capacity measured by the electric-generation capacity measurement unit 112 is to be input into the certificate of electric-generation issuance unit 114.

The electricity generated by the photovoltaic panel 111 is to be input into the electric power transmission unit 113 via the electric-generation capacity measurement unit 112. The electric power transmission unit 113, o which the electricity generated by the photovoltaic panel 111 has been input, transmits the input electricity to the power consuming device 10 or the electric storage apparatus 12. Note that in this description herein, the electricity input by the electric power transmission unit 113 is to be transmitted to the electric storage apparatus 12.

The certificate of electric-generation issuance unit 114 to which the information on the electric-generation capacity has been input from the electric-generation capacity measurement unit 112 issues a certificate of electric-generation to the input information on the electric-generation capacity. Note that the detail functional configuration of the certificate of electric-generation issuance unit 114 will be described later. The certificate of electric-generation that has been issued by the certificate of electric-generation issuance unit 114 is to be input into the communication unit 115. The communication unit 115 to which the certificate of electric-generation has been input transmits the input certificate of electric-generation to the electric storage apparatus 12.

(Details of the Certificate of Electric-Generation Issuance Unit 114)

An explanation will be given on the detail functional configuration of the certificate of electric-generation issuance unit 114. As shown in FIG. 3, the certificate of electric-generation issuance unit 114 is configured from a signature generation unit 1141, a storage unit 1142, and a certificate generation unit 1143. Note that the storage unit 1142 stores a pair of a secret key and a public key which have been generated in advance. Further, the public key stored in the storage unit 1142 is assumed to have been certified by the certificate authority 4.

In the event when the information on the electric-generation capacity is input from the electric-generation capacity measurement unit 112 to the certificate of electric-generation issuance unit 114, the input information on the electric-generation capacity is to be input into the signature generation unit 1141. The signature generation unit 1141 to which the information on the electric-generation capacity has been input reads a secret key from the storage unit 1142, and generates a digital signature based on the information on the electric-generation capacity using the secret key that has been read. The digital signature generated by the signature generation unit 1141 is to be input into the certificate generation unit 1143 along with the information on the electric-generation capacity. The certificate generation unit 1143, to which the digital signature and the information on the electric-generation capacity have been input, generates a certificate of electric-generation contained the digital signature and the information on the electric-generation capacity which have been input. Subsequently, the certificate of electric-generation generated by the certificate generation unit 1143 is to be input into the communication unit 115.

(Content of a Certificate of Electric-Generation)

In this example, a certificate of electric-generation contains information on electric-generation capacity and a digital signature. By using this certificate of electric-generation, it is possible to certify the electric-generation capacity of the electricity that has been generated from green electric power generation. However, there are some cases where it is desired to add information regarding types of green power generation and area of power generation, or the like.

For example, when the power price varies depending on the amount of emission of greenhouse gas generated at the time of power generation, it is necessary to know the type of the green power generation in order to determine the power price for trading. In such a case, it is preferable to add information that indicates the type of the green power generation (hereinafter, referred to as the electric power generation method data) in the certificate of electric-generation. In the examples of FIG. 2 and FIG. 3, the electric power generation method data that indicates photovoltaic generation is added to the certificate of electric-generation. In case of a generation method utilizing renewable sources, the amount of emission of greenhouse gas is nearly zero, however, in case of environmentally friendly energy generation, the emission amount of greenhouse gases vary depending on fuel used for electric power generation. In this case, types of fuels are to be indicated in the electric power generation method data. It may be possible to develop a reference index indicating a degree of environmental load at the time of power generation, and to add information indicating that reference index as the electric power generation method data.

If (as a regional policy) it is expected to have a type of power consumption that is locally produced and locally consumed, it is preferable to add information on area of generation (hereinafter, referred to as the area information) to a certificate of electric-generation. If the area of generation is away from the area of consumption geographically, it causes power transmission loss when the electric power is transmitted through power transmission lines. Moreover, performing repeatedly DC/AC conversion and frequency conversion causes power loss. For these reasons, in many cases, the type of power consumption that is locally produced and consumed locally is desired. In the event of promoting such power consumption type, generally a policy is applied so that selling price of electricity locally produced and locally consumed is set expensive, and buying price of electricity locally produced and locally consumed is set inexpensive. Then, the certificate of electric-generation is expected to be added with the area information in order to certify whether it is the one locally produced and locally consumed. Information on a desired area where to be consumed may be added as the area information.

By adding such information to a certificate of electric-generation, the value of the certificate of electric-generation can be certified more precisely, and this contributes to the promotion of the green electric power generation equipment which has higher environmental performance. It also contributes to the development of the regional policy and regional services, or to the formation of a trading market which is region-oriented. Note that it is desirable that various kinds of information added to the certificate of electric-generation are ensured of reliability by having a digital signature, similarly to the information on electric-generation capacity. In this case, the addition of the digital signature is performed by the signature generation unit 1141. Moreover, the addition of various kinds of information and the corresponding digital signature is performed by the certificate generation unit 1143.

The configuration of the green power generation apparatus 11 according to the present embodiment has been explained above.

(1-3: Configuration of Electric Storage Apparatus 12)

Next, with reference to FIG. 4 and FIG. 5, the configuration of the electric storage apparatus 12 according to the present embodiment will be explained. FIG. 4 is an explanatory diagram for illustrating a functional configuration of the electric storage apparatus 12 according to the present embodiment. FIG. 5 is an explanatory diagram for illustrating a functional configuration of the certificate of electric-storage issuance unit 125 according to the present embodiment.

(Overall Configuration)

As shown in FIG. 4, the electric storage apparatus 12 includes an electric power receiving unit 121, a charge/discharge control unit 122, a battery 123, an electric power transmission unit 124, a certificate of electric-storage issuance unit 125, and a communication unit 126.

(At Receiving)

At first, the electricity supplied by the green power generation apparatus 11 is to be received by the electric power receiving unit 121. The electricity received by the electric power receiving unit 121 is to be input into the charge/discharge control unit 122. The charge/discharge control unit 122 to which the electricity has been input by the electric power receiving unit 121 inputs the input electricity to the battery 123 so as to charge the battery 123. At this time, the certificate of electric-storage issuance unit 125 receives a certificate of electric-generation from the green power generation apparatus 11 via the communication unit 126. The certificate of electric-storage issuance unit 125 which has received the certificate of electric-generation issues a certificate of electric-storage based on the received certificate of electric-generation and the storage efficiency of the battery 123. Note that the detail description of the functional configuration of the certificate of electric-storage issuance unit 125 will be described later.

(At Transmitting)

If an instruction for discharging is received from the interface apparatus 13 via the communication unit 126, the instruction is to be input into the charge/discharge control unit 122 via the communication unit 126. The charge/discharge control unit 122 to which the instruction for discharging has been input discharges the amount of electricity based on the instruction from the battery 123. The electricity that has been discharged from the battery 123 by the charge/discharge control unit 122 is to be input into the electric power transmission unit 124, and is to be transmitted to the power consuming device 10, the community power network 2, or the electric power company 3 from the electric power transmission unit 124. In this example, however, it is assumed to be transmitted to the electric power company 3. At this time, the charge/discharge control unit 122 inputs information on the amount of discharged electricity into the certificate of electric-storage issuance unit 125.

The certificate of electric-storage issuance unit 125 in which the information on the amount of discharged electricity issues, based on the input information on the amount of discharged electricity, a certificate of electric-storage that certifies the electricity of the amount of discharged has been generated from green power generation. If it is possible to use a certificate of electric-storage issued at the time of receiving the electricity from the green power generation apparatus 11, the certificate of electric-storage will be used. In this example, however, it is assumed that the certificate of electric-storage issuance unit 125 issues a certificate of electric-storage corresponding to the amount of the discharged electricity. The certificate of electric-storage issuance unit 125 which has issued the certificate of electric-storage corresponding to the amount of discharged electricity transmits the certificate of electric-storage to the interface apparatus 13 via the communication unit 126.

(Detail Description of the Certificate of Electric-Storage Issuance Unit 125)

The detail functional configuration of the certificate of electric-storage issuance unit 125 will be explained. As shown in FIG. 5, the certificate of electric-storage issuance unit 125 is configured from a signature verification unit 1251, an electric-generation capacity modification unit 1252, a signature generation unit 1253, a storage unit 1254, and a certificate generation unit 1255. Note that the storage unit 1254 stores a pair of a secret key and a public key which have been generated in advance. Further, the public key stored in the storage unit 1254 is assumed to have been certified by the certificate authority 4.

(At Receiving)

At first, the certificate of electric-generation received by the certificate of electric-storage issuance unit 125 via the communication unit 126 is to be input into the signature verification unit 1251. The signature verification unit 1251 to which the certificate of electric-generation has been input acquires a public key certificate of the green power generation apparatus 11 from the certificate authority 4 via the communication unit 126. Then the signature verification unit 1251 uses the public key contained in the public key certificate to verify the validity of the digital signature contained in the certificate of electric-generation. If succeeded in the verification of the digital signature, the signature verification unit 1251 inputs the information on the electric-generation capacity contained in the certificate of electric-generation into the electric-generation capacity modification unit 1252.

If area information or the like is added to the certificate of electric-generation, the signature verification unit 1251 verifies the digital signature in the same way, and if succeeded, the signature verification unit 1251 inputs the area information or the like into the certificate generation unit 1255. In this example, however, it is assumed that only information on the electric-generation capacity is contained in the certificate of electric-generation.

The electric-generation capacity modification unit 1252 to which the information on the electric-generation capacity has been input by the signature verification unit 1251 acquires information that indicates the charge efficiency of the battery 123 from the charge/discharge control unit 122. Then the electric-generation capacity modification unit 1252 multiplies the electric-generation capacity by the charge efficiency of the battery 123 to calculate the modified electric-generation capacity adjusted based on the loss of electricity in the battery 123. Note that if the electric-generation capacity which the certificate of electric-generation indicates are used as it is, the value of the electricity lost in the battery 123 (the electricity lost without being consumed) remains. For this reason, the electric-generation capacity is to be modified by the electric-generation capacity modification unit 1252.

The information on the modified electric-generation capacity calculated by the electric-generation capacity modification unit 1252 is to be input into the signature generation unit 1253. The signature generation unit 1253 to which the information on the modified electric-generation capacity has been input reads a secret key from the storage unit 1254, and generates a digital signature based on the information on the modified electric-generation capacity using the secret key that has been read. The digital signature generated by the signature generation unit 1253 is to be input into the certificate generation unit 1255 along with the information on the modified electric-generation capacity. The certificate generation unit 1255, to which the digital signature and the information on the modified electric-generation capacity have been input, generates a certificate of electric-storage contained the digital signature and the information on the modified electric-generation capacity which have been input.

Note that if area information or the like is contained in the certificate of electric-generation, the signature generation unit 1253 generates a digital signature for the area information or the like, and the certificate generation unit 1255 generates a certificate of electric-storage containing area information or the like. Note that the certificate generation unit 1255 may include the area information or the like that is contained in the certificate of electric-generation into the certificate of electric-storage as it is.

(At Transmitting)

If the electric storage apparatus 12 receives an instruction to discharge from the interface apparatus 13 via the communication unit 126, information on the amount of discharged electricity is input to the certificate of electric-storage issuance unit 125. The information on the amount of discharged electricity that has been input into the certificate of electric-storage issuance unit 125 is to be input into the certificate generation unit 1255. The certificate generation unit 1255, to which the information on the amount of discharged electricity has been input, generates a certificate of electric-storage corresponding to the amount of discharged electricity to transmit to the discharging destination (the electric power company 3 in this example) via the communication unit 126. Note that there are two methods for generating the certificate of electric-generation corresponding to the amount of discharged electricity as follows.

The first method is to generate a plurality of certificates of electric-storage corresponding to a prescribed amount of electricity (modified electric-generation capacity) per unit at the time of receiving the electricity. In other words, when receiving one certificate of electric-generation corresponding to a certain amount of electric-generation capacity, this method is not for generating only one certificate of electric-storage corresponding to the modified electric-generation capacity of its electric-generation capacity but for generating necessary amount of certificates of electric-storage in accordance with the amount of electricity per unit which corresponds to the electric-generation capacity indicated by the certificate of electric-generation. Therefore, if this method is applied, at the time of receiving the electricity, as many as (the electric-generation capacity/the amount of electricity per unit) certificates of electric-storage will be generated. If certificates of electric-storage are generated piece by piece for each unit of electricity and are stored in the storage unit 1254, it is considered sufficient that certificates of electric-storage are provided as many as the amount of discharged electricity to the discharging destination at the time of discharging electricity.

The second method is to generate one piece of certificate of electric-storage corresponding to the amount of discharged electricity at the time of discharging electricity. When receiving one certificate of electric-generation corresponding to a certain amount of electric-generation capacity, this method is for generating one certificate of electric-storage corresponding to the modified electric-generation capacity of its electric-generation capacity, and for storing the certificate of electric-storage into the storage unit 1254. At the time of discharging electricity, the certificate of electric-storage stored in the storage unit 1254 will be read out, the modified electric-generation capacity is divided into the first modified electric-generation capacity which equals to the amount of charged electricity, and the second modified electric-generation capacity which is calculated by subtracting the first modified electric-generation capacity from the original modified electric-generation capacity, and certificates of electric-storage corresponding to each of the first and the second modified electric-generation capacity will be generated. Subsequently, the certificate of electric-storage for the first modified electric-generation capacity will be provided to the discharging destination, while the certificate of electric-storage for the second modified electric-generation capacity will be stored in the storage unit 1254.

Using either method, a certificate of electric-storage corresponding to the amount of discharged electricity will be acquired and the certificate of electric-storage will be provided to the discharging destination via the communication unit 126. It is not necessary to recreate the certificate of electric-storage when using the above first method, however, when using the above second method it is necessary to recreate the certificates of electric-storage (creating the first and the second certificates of electric-storage). In this case, a process to recreate the certificate of electric-storage will be performed by the signature generation unit 1253 and the certificate generation unit 1255 similarly to the process of creating the certificate of electric-storage performed at the time of receiving electricity. Note that the two methods described herein are an example and other methods may be applied to create certificates of electric-storage corresponding to the amount of discharged electricity. In this specification, it is assumed that certificates of electric-storage corresponding to the amount of discharged electricity are generated by the second method.

The configuration of the electric storage apparatus 12 according to the present embodiment has been explained as above.

(1-4: Configuration of Interface Apparatus 13)

With reference to FIG. 6, the configuration of the interface apparatus 13 according to the present embodiment will be explained. FIG. 6 is an explanatory diagram for illustrating a functional configuration of an interface apparatus according to the embodiment of the present invention.

As shown in FIG. 6, the interface apparatus 13 includes a communication unit 131, a central processing unit 132, a storage unit 133, a display unit 134 and an input unit 135.

When the electricity is discharged from the electric storage apparatus 12, a user inputs information on the amount of discharged electricity or the like using the input unit 135. The information that has been input using the input unit 135 is to be input into the electric storage apparatus 12 via the central processing unit 132 and the communication unit 131. When the process of discharging electricity is performed by the electric storage apparatus 12, the communication unit 131 receives a certificate of electric-storage. The certificate of electric-storage received by the communication unit 131 is to be input into the central processing unit 132. The central processing unit 132, to which the certificate of electric-storage has been input, transmits the input certificate of electric-storage to a discharging destination (the electric power company 3 in this example) via the communication unit 131.

Note that the interface apparatus 13 provides functions of user interface for the user to input or display information when the user buys or sells the electricity. The process for realizing such functions is performed by the central processing unit 132. For example, the central processing unit 132 acquires information on the buying price of electricity and the selling price of electricity from the electric power company 3 or the like via the communication unit 131, and displays the information on the display unit 134. Moreover, the central processing unit 132 inputs the information on the amount of electricity to buy or the amount of electricity to sell, which has been input using the input unit 135, into the display unit 134, or transmits the information to the electric power company 3 or the like via the communication unit 131.

Further, when the user input an instruction to buy electricity using the input unit 135, the central processing unit 132 transmits an instruction of discharging electricity and information on the amount of discharged electricity to the electric storage apparatus 12 via the communication unit 131. Note that the storage unit 133 is used to store information received from the electric storage apparatus 12 or the electric power company 3, or information that a user has input, or used to store a public key or the like of the green power generation apparatus 11 or the electric storage apparatus 12 as needed. The storage unit 133 is used to store a program that defines operations of the central processing unit 132.

The configuration of the interface apparatus 13 according to the present embodiment has been explained as above.

### 2: Second Embodiment

### Structure of Power Trading Market for Individual Consumer

Hereinafter, the second embodiment of the present invention will be explained. Note that, structural elements that have function and structure substantially same with the structural elements according to the above first embodiment are denoted with the same reference numerals, and repeated explanation of these structural elements is omitted.

(2-1: Configuration of Power Trade System)

Firstly, with reference to FIG. 7, the configuration of the power trade system according to the present embodiment will be explained. FIG. 7 is an explanatory diagram for illustrating a functional configuration of a power trade server according to the embodiment of the present invention. Note that a word of “household” will be used similarly to the above first embodiment so that a concrete configuration can be grasped easily, and the expression of “household” herein means a size that an individual of electric power consumer can handle by himself.

As shown in FIG. 7, the power trade system according to the present embodiment includes a home power network 1, a plurality of home power networks 2 (the first community power network to the N-th community power network), a certificate authority 4 and a power trade server 5. Note that an electric power company 3 may be included similarly to FIG. 1. Moreover, the home power network 1 includes the power consuming device 10, the green power generation apparatus 11, the electric storage apparatus 12 and the interface apparatus 13. The home power network 1 is assumed to be connected with a plurality of the community power networks 2 (the first community power network to the N-th community power network) via power lines.

The major difference between FIG. 1 and FIG. 7 is an existence of the power trade server 5. As described in the above explanation of the first embodiment, there is a price gap between the ordinary electric power, which has been produced using fossil fuels or the like, and the green power, and if a structure is developed in which the electricity can be traded at the price of green power by adding a certificate of electric-generation or a certificate of electric-storage to a certain electric power, the certificate of electric-generation and the certificate of electric-storage will have monetary value. Further, it will be possible to develop a market where the certificate of electric-generation or the certificate of electric-storage itself can be traded independently after being securitized.

The above power trade server 5 is a server apparatus for managing power trade such as the one described above, and for managing trade of the certificate of electric-generation or the certificate of electric-storage, or the like. The present embodiment relates to a method for managing such power trade, and trade of the certificate of electric-generation or the certificate of electric-storage, or the like. Hereinafter, functions of the electric storage apparatus 12 added to the configuration of the above first embodiment, functions of the interface apparatus 13, and functions of the power trade server 5, which are for realizing management of the power trade according to the present embodiment, will be explained one by one.

Although the certificate of electric-generation and the certificate of electric-storage have a difference in whether electricity loss occurred at the time of storage was taken into consideration, they are substantially identical in the viewpoint that they are both a digital certificate that certifies it is green power. Especially when the loss at the time of storage is small enough to be negligible, the certificate of electric-generation and the certificate of electric-storage become the same. For this reason, in the following description, it is assumed that the certificate of electric-storage will be used for power trade.

The configuration of the power trade according to the present embodiment has been explained as above.

(2-2: Configuration of Electric Storage Apparatus 12)

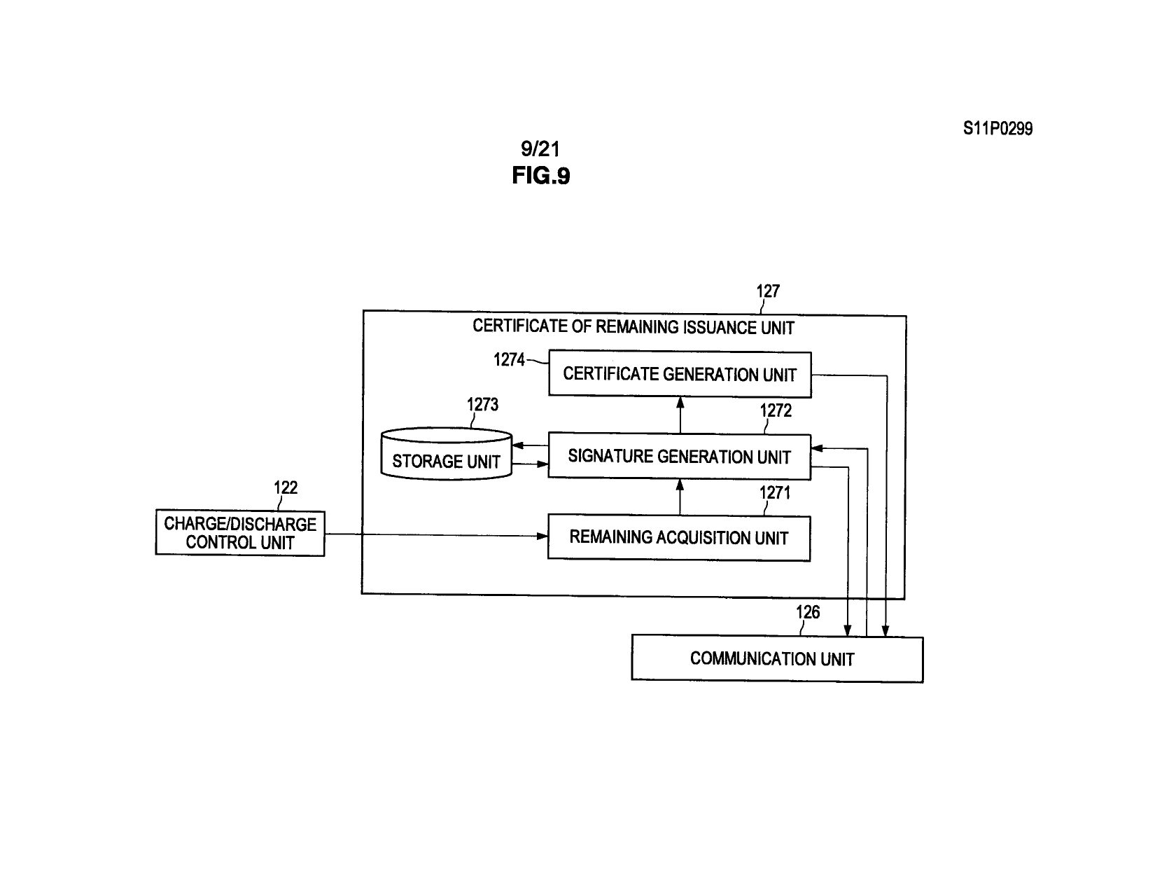

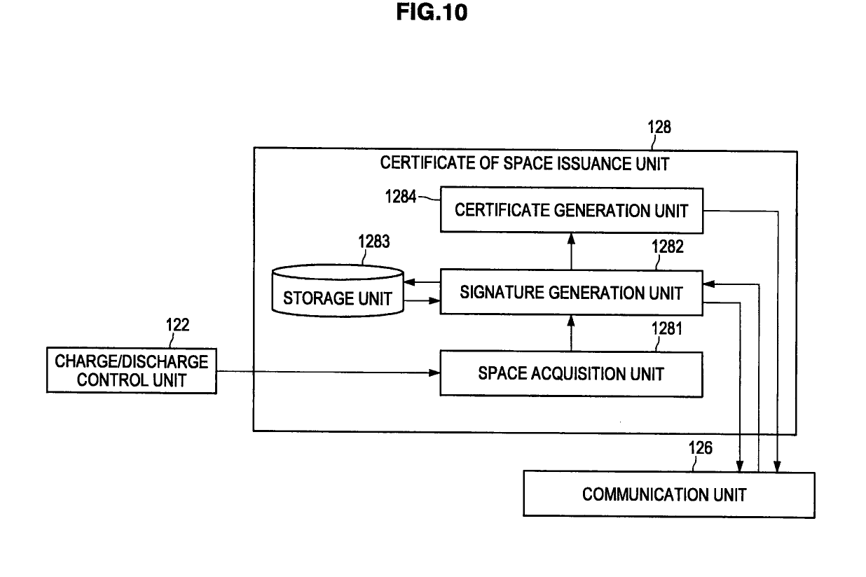

With reference to FIG. 8 to FIG. 10, the configuration of the electric storage apparatus 12 according to the present embodiment will be explained. FIG. 8 is an explanatory diagram for illustrating a functional configuration of the electric storage apparatus 12 according to the present embodiment. FIG. 9 is an explanatory diagram for illustrating a functional configuration of a certificate of remaining issuance unit 127 according to the present embodiment. FIG. 10 is an explanatory diagram for illustrating a functional configuration of a certificate of space issuance unit 128 according to the present embodiment.

As shown in FIG. 8, the electric storage apparatus 12 includes the electric power receiving unit 121, the charge/discharge control unit 122, the battery 123, the electric power transmission unit 124, the certificate of electric-storage issuance unit 125, the communication unit 126, the certificate of remaining issuance unit 127 and the certificate of space issuance unit 128. Note that functions of the electric power receiving unit 121, the charge/discharge control unit 122, the battery 123, the electric power transmission unit 124, the certificate of electric-storage issuance unit 125, the communication unit 126 are the same as the electric storage apparatus 12 according to the above first embodiment, therefore detail explanation on these structural elements will be omitted and explanation will be given on the certificate of remaining issuance unit 127 and the certificate of space issuance unit 128 only.

(Introduction)

Not only to power trade, there exist various types of commodities trading in the world. For example, various financial commodities are circulating in the market regarding interest, currency, loan receivable, securities, or the like. Moreover, derivatives such as futures, swaps, options, or the like are also widely utilized. For example, futures are contracts to trade cash commodities on a future date at a price specified today. The cash commodities include various types of commodities, such as oil, power, emission credit, wheat, soybeans, corn, or the like.

Originally, futures used to execute a contract on due date, being associated with delivery and receipt of the cash commodities. Today, however, the general transaction form of futures is the one in which no actual commodities are neither delivered nor received, and offsetting transaction is executed by due date for offsetting. For this reason, transaction prices of cash commodities often move up and down rapidly under speculative transactions.

However, the power trading market assumed in the present embodiment is a market in which individual electric power consumers join on the assumption that cash commodities are to be delivered and received. Therefore, it is strongly desired to eliminate risks, such as a gyrating market price caused by those speculative transactions, or sagging power supply on the delivery date. To eliminate such risks, it is necessary to exclude players who repeatedly sell and buy in a short period of time less than the necessary time for the delivery of commodities, to exclude players who do not own any cash commodities to be delivered, or to exclude players who are difficult to receive cash commodities.

Although futures have been described as an example here, however, what the present embodiment assumes is real-time power trade. Therefore, it is preferable that the power trade server 5 manages information in real time, the information such as whether a player who has placed a sell order currently has remaining battery level enough to deliver, or whether a player who has placed a buy order keeps battery space enough to receive. However, as the number of players increases, it will be difficult for the power trade server to manage each player's remaining battery level and battery space in real time. The present embodiment is invented to resolve such issues.

(Functions of the Certificate of Remaining Issuance Unit 127)

The power trade system according to the present embodiment utilizes a certificate of remaining that certifies remaining battery level in order to manage remaining battery level of a player who has placed a buy order. This certificate of remaining is issued by the certificate of remaining issuance unit 127 of the electric storage apparatus 12.

As shown in FIG. 9, the certificate of remaining issuance unit 127 is configured from a remaining acquisition unit 1271, a signature generation unit 1272, a storage unit 1273 and a certificate generation unit 1274. Note that the storage unit 1273 stores a pair of a secret key and a public key which have been generated in advance. Further, the public key stored in the storage unit 1273 is assumed to have been certified by the certificate authority 4.

If a user places a sell order using the interface apparatus 13, a notification indicating the sell order is to be input into the charge/discharge control unit 122 via the communication unit 126. The charge/discharge control unit 122 received this notification detects remaining battery level of the battery 123, and inputs information on the detected remaining battery level into the certificate of remaining issuance unit 127. The information on the remaining battery level, which has been input into the certificate of remaining issuance unit 127, will be acquired by the remaining acquisition unit 1271. And the information on the remaining battery level acquired by the remaining acquisition unit 1271 is to be input into the signature generation unit 1272.

The signature generation unit 1272 to which the information on the remaining battery level has been input reads a secret key from the storage unit 1273, and generates a digital signature based on the information on the remaining battery level using the secret key that has been read. The digital signature generated by the signature generation unit 1272 is to be input into the certificate generation unit 1274 along with the information on the remaining battery level. The certificate generation unit 1274 to which the digital signature and the information on the remaining battery level have been input generates a certificate of remaining contained the digital signature and the information on the remaining battery level which have been input. Subsequently, the certificate of remaining generated by the certificate generation unit 1274 is to be input into the communication unit 126. This certificate of remaining is to be transmitted to the interface apparatus 13 via the communication unit 126, and to be transmitted to the power trade server 5 via the interface apparatus 13.

(Functions of the Certificate of Space Issuance Unit 128)

The power trade system according to the present embodiment utilizes a certificate of space that certifies battery space in order to manage battery space of a player who has placed a sell order. This certificate of space is issued by the certificate of space issuance unit 128 of the electric storage apparatus 12.

As shown in FIG. 10, the certificate of space issuance unit 128 is configured from a space acquisition unit 1281, a signature generation unit 1282, a storage unit 1283 and a certificate generation unit 1284. Note that the storage unit 1283 stores a pair of a secret key and a public key which have been generated in advance. Further, the public key stored in the storage unit 1283 is assumed to have been certified by the certificate authority 4.

If a user places a buy order using the interface apparatus 13, a notification indicating the buy order is to be input into the charge/discharge control unit 122 via the communication unit 126. The charge/discharge control unit 122 received this notification detects battery space of the battery 123, and inputs information on the detected battery space into the certificate of space issuance unit 128. The information on the battery space, which has been input into the certificate of space issuance unit 128, will be acquired by the space acquisition unit 1281. And the information on the battery space acquired by the space acquisition unit 1281 is to be input into the signature generation unit 1282.

The signature generation unit 1282 to which the information on the battery space has been input reads a secret key from the storage unit 1283, and generates a digital signature based on the information on the battery space using the secret key that has been read. The digital signature generated by the signature generation unit 1282 is to be input into the certificate generation unit 1284 along with the information on the battery space. The certificate generation unit 1284 to which the digital signature and the information on the battery space have been input generates a certificate of space contained the digital signature and the information on the battery space which have been input. Subsequently, the certificate of space generated by the certificate generation unit 1284 is to be input into the communication unit 126. This certificate of space is to be transmitted to the interface apparatus 13 via the communication unit 126, and to be transmitted to the power trade server 5 via the interface apparatus 13.

The configuration of the electric storage apparatus 12 has been explained as above. As described above, a certificate of remaining is to be transmitted to the power trade server 5 when placing a sell order, while a certificate of remaining is to be transmitted to the power trade server 5 when placing a buy order. The power trade server 5 can limit reception of buy orders or sell orders based on certificates of remaining and certificates of space which are being transmitted on a real-time basis. As a result, it can be possible to avoid risks which cash commodities will be unable to be delivered or received.

(2-3: Configuration of Interface Apparatus 13)

With reference to FIG. 11, and FIG. 12, a configuration of the interface apparatus 13 according to the present embodiment will be explained. FIG. 11 is an explanatory diagram for illustrating a functional configuration of the interface apparatus 13 according to the present embodiment. FIG. 12 is an explanatory diagram for illustrating a functional configuration of a certificate of consumption issuance unit 136 according to the present embodiment.

As shown in FIG. 11, the interface apparatus 13 includes the communication unit 131, the central processing unit 132, the storage unit 133, the display unit 134 and the input unit 135. Note that the communication unit 131, the storage unit 133, the display unit 134 and the input unit 135 are substantially same as the interface apparatus 13 according to the above first embodiment, therefore detail explanation on these structural elements will be omitted and explanation will be given on the functions of the central processing unit 132 (the certificate of consumption issuance unit 136) only.

As described above, restricting reception of buy orders or sell orders based on a certificate of remaining or a certificate of space makes it possible to avoid risks which cash commodities will be unable to be delivered or received. However, the remaining battery level of the battery 123 is getting decreased every second. For that reason, it is preferable to admit a user to place a sell order up to the amount of electricity which is calculated by subtracting a certain margin from the remaining battery level that the certificate of remaining indicates. On the other hand, it is acceptable to admit a user to place a buy order up to the amount of electricity which equals to the battery space that the certificate of space indicates.

Moreover, if a certain amount of electricity consumption is expected by the time of actual delivery of the commodities, it is preferable to admit to place a sell order up to the upper limit of electricity upon consideration of the certain amount of electricity consumption concerned. The certificate of consumption issuance unit 136 which is one of the functions of the central processing unit 132 includes a function to issue a certificate of consumption that certifies such amount of presumption of electricity consumption.

As shown in FIG. 12, the certificate of consumption issuance unit 136 is configured from a consumption setting unit 1361, a signature generation unit 1362, a storage unit 1363 and a certificate generation unit 1364. Note that the storage unit 1363 stores a pair of a secret key and a public key which have been generated in advance. Further, the public key stored in the storage unit 1363 is assumed to have been certified by the certificate authority 4.

The consumption setting unit 1361 monitors the amount of electricity consumption of a power consuming device 10. The consumption setting unit 1361 detects a power consuming device 10 which constantly consumes electricity, and calculates the amount of electricity consumption per unit of time consumed by the detected power consuming device 10. Note that if the user specifies the power consuming device 10 by using the input unit 135, the amount of electricity consumption per unit of time consumed by the specified power consuming device 10 will be calculated. Then when the user places a sell order using the input unit 135, the consumption setting unit 1361 calculates the electricity to be consumed in a prescribed period of time before the actual delivery based on the amount of electricity consumption per unit of time that has been calculated in advance, and set the result as the electricity consumption.

The information on the electric consumption that has been set by the consumption setting unit 1361 is to be input into the signature generation unit 1362. The signature generation unit 1362 to which the information on the electric consumption has been input reads a secret key from the storage unit 1363, and generates a digital signature based on the information on the electric consumption using the secret key that has been read. The digital signature generated by the signature generation unit 1362 is to be input into the certificate generation unit 1364 along with the information on the electric consumption. The certificate generation unit 1364 to which the digital signature and the information on the electric consumption have been input generates a certificate of electric consumption contained the digital signature and the information on the electric consumption which have been input. The certificate of electric consumption generated by the certificate generation unit 1364 is to be input into the communication unit 131, and is transmitted to the power trade server 5 via the communication unit 131.

The configuration of the interface apparatus 13 according to the present embodiment has been explained as above. As above, using the certificate of consumption makes it possible to place a buy order upon due consideration of the amount of electricity which expects consumption within the home power network 1 by the time of the actual delivery of cash commodities.

(2-4: Configuration of Power Trade Server 5)

With reference to FIG. 13, functions of the power trade server 5 according to the present embodiment will be explained. FIG. 13 is an explanation chart for illustrating a functional configuration of the power trade server 5 according to the embodiment.

As shown in FIG. 13, the power trade server 5 includes a communication unit 51, a order reception unit 52, a market price decision unit 53, a certificate acquisition unit 54, a power purchase limitation unit 55, a power selling limitation unit 56, incoming/feeding power control unit 57, a local market price collection unit 58, and a price forecasting unit 59.

(Trading Function)

When a user places an order, information of the order is to be input into the order reception unit 52 via the communication unit 51. The order reception unit 52 receives the order based on the information of the order that has been input, and inputs the order into the market price decision unit 53. However, the order is not fixed at this stage. The market price decision unit 53 determines a buying price and a selling price (hereinafter, referred to as the market price) based on the balance of supply and demand depending on the amount of orders that the order reception unit 52 has received. The information on the market price determined by the market price decision unit 53 is to be input into the order reception unit 52.

Note that the trading market may be divided into units of the community power network 2. In this case, market prices in each of the community power network 2 are to be studied and collected by the local market price collection unit 58. Subsequently, the information of market prices in each of the community power network 2 collected by the local market price collection unit 58 is to be input into the market price decision unit 53. In this case, the market price decision unit 53 determines the whole market price based on the information of the market prices in each of the community power network 2. Note that the actual deliveries in the electricity trading market of each of the community power network 2 may be executed suing the community electric storage apparatus 21 (refer to FIG. 7) which has been arranged in each of the community power network 2.

As described above, the order reception unit 52 does not make an order fixed at the time of reception of the order from a user. When the order reception unit 52 receives the order, the certificate acquisition unit 54 acquires various certificates from the user before fixing the order. The certificate acquisition unit 54 includes a certificate of space acquisition unit 541, a consumption certificate acquisition unit 542, a certificate of remaining acquisition unit 543, and a certificate of electric-storage acquisition unit 544.

(Buy Order)

If the order received by the user is a buy order, the certificate acquisition unit 54 acquires a certificate of space from the certificate of space acquisition unit 541, and acquires a certificate of consumption from the consumption certificate acquisition unit 542. The certificate of space acquired by the certificate of space acquisition unit 541, and the certificate of consumption acquired by the consumption certificate acquisition unit 542 are to be input into the power purchase limitation unit 55. The power purchase limitation unit 55 acquires a public key certificate of the electric storage apparatus 12 from the certificate authority 4, and verifies a digital signature contained in the certificate of space and the certificate of consumption using a public key contained in the acquired public key certificate. If the certificate of consumption may be impossible to be acquired, however, the digital signature contained in the certificate of space only will be verified.

If succeeded in the verification, the power purchase limitation unit 55 reads information on battery space contained in the certificate of space, and information on electricity consumption contained in the certificate of consumption, and inputs them into the order reception unit 52. Comparing information on the amount of electricity to buy specified by the buy order of the user, and information on remaining battery space and information on electricity consumption that the power purchase limitation unit 55 has been input, the order reception unit 52 fixes the buy order if the amount of electricity to buy is less than (the remaining battery space+electricity consumption). Subsequently, the order reception unit 52 inputs the information on the amount of electricity to buy into the incoming/feeding power control unit 57.

The incoming/feeding power control unit 57, to which the information on the amount of electricity to buy has been input, executes a control instruction so that the electricity for the amount of electricity to buy will be supplied to the user who placed the buy order. This control instruction is to be transmitted to the electric storage apparatus 12 of the electricity supplier, the community electric storage apparatus 21, or a prescribed storage place via the communication unit 51. The electric storage apparatus 12 of the electricity supplier, the community electric storage apparatus 21, or a prescribed storage place supplies electricity for the amount of electricity to buy to the electric storage apparatus 12 of the user who has placed the sell order.

(Sell Order)

If the order received by the user is a sell order, the certificate acquisition unit 54 acquires a certificate of remaining from the certificate of remaining acquisition unit 543, and acquires a certificate of electric-storage from the certificate of electric-storage acquisition unit 544. The certificate of remaining acquired by the certificate of remaining acquisition unit 544 is to be input into the power selling limitation unit 56. The power selling limitation unit 56 acquires a public key certificate of the electric storage apparatus 12 from the certificate authority 4, and verifies a digital signature contained in the certificate of remaining using a public key contained in the acquired public key certificate. If succeeded in the verification, information on the remaining battery level contained in the certificate of remaining will be input into the order reception unit 52.

The certificate of electric-storage acquisition unit 544 acquires the public key certificate of the electric storage apparatus 12 from the certificate authority 4, and verifies a digital signature contained in the acquired certificate of electric-storage using the public key contained in the acquired public key certificate. If succeeded in the verification, information on modified electric-generation capacity contained in the certificate of electric-storage will be input into the order reception unit 52. As described earlier, the certificate of electric-storage is a certificate that certifies the electricity is green power. Therefore, the electricity for the modified electric-generation capacity contained in the certificate of electric-storage is to be bought at the green power price. If the electricity to sell is not green power, a certificate of electric-storage will not be acquired. In this case, the certificate of electric-storage acquisition unit 544 inputs a notification that the electricity is not green power into the order reception unit 52. Here, however, it is assumed that a certificate of electric-storage can be acquired.

When the information on remaining battery level and the information on modified electric-generation capacity have been input, the order reception unit 52 fixes the sell order if the amount of electricity to sell is less than the remaining battery level, comparing information on the amount of electricity to sell specified by the buy order of the user and information on the remaining battery level that the power selling limitation unit 56 has input. Subsequently, the order reception unit 52 acquires a market price of green power from the market price decision unit 53, and fixes the sell order at the market price of green power for the amount of the modified electric-generation capacity that the certificate of electric-storage acquisition unit 544 has input, out of the amount of electricity to sell specified by the sell order. Further, the order reception unit 52 acquires a market price of green power from the market price decision unit 53, and fixes the sell order at the general market price for the amount of electricity to sell that is subtracted the amount of the modified electric-generation capacity from the amount of the electricity to sell specified by the sell order.

Then the order reception unit 52 inputs information on the amount of electricity to sell to the incoming/feeding power control unit 57. The incoming/feeding power control unit 57 to which the information on the amount of electricity to sell has been input executes a control instruction so that the electricity for the amount of electricity to sell will be transmitted to the prescribed storage place from the electric storage apparatus 12 of the user who has placed the sell order. This control instruction will be transmitted to the electric storage apparatus 12 of the user who has placed the sell order via the communication unit 51. The electric storage apparatus 12 that has received the control instruction transmits the electricity for the amount of the electricity to sell to the prescribed storage place.

(Price Forecast Function)

Subsequently, the price forecasting by the power trade server 5 will be explained. The price forecasting unit 59 includes a market price forecasting unit 591, a storage unit 592, and an environmental information collection unit 593. The market price forecasting unit 591 forecasts future market price based on changes in the buying and selling prices of electricity determined by the market price decision unit 53 in the past, the current buying and selling prices, changes in the amount of trade in the past, the current amount of trade, and environmental information collected by the later-described environmental information collection unit 593.

The environmental information collection unit 593 is a method for collecting information regarding environmental factors affecting the amount of electricity by green power. For example, the environmental information collection unit 593 collects the environmental information regarding weather of whether forecast in the past and at present. Moreover, the environmental information collection unit 593 accumulates the collected environmental information into the storage unit 592. The environmental information accumulated in the storage unit 592 is referred by the market price forecasting unit 591, and will be used for forecasting of market prices. For example, if the weather has been rainy or cloudy with bad sunshine condition for many days, it is forecasted that the amount of power supply by photovoltaic generation would be decreased. In this case, the price of green power is to be forecasted higher than usual.

The market price predicted in such manner will be transmitted to the interface apparatus 13 of each user and the electric power company 3 via the communication unit 51.

The function of the power trade server 5 according to the present embodiment has been explained as above.

### 3: Third Embodiment

### Services Based on a Green Certificate

Hereinafter, the third embodiment of the present invention will be explained. Note that, structural elements that have function and structure substantially same with the structural elements according to the above first and second embodiment are denoted with the same reference numerals, and repeated explanation of these structural elements is omitted.

(3-1: Configuration of Mobile Device 6)

With reference to FIG. 14, an explanation will be given on configurations of a mobile device 6 and a power reception apparatus 7 according to the third embodiment of the present invention. FIG. 14 is an explanatory diagram for illustrating a configuration of a green power generation system according to the present embodiment. Note that a concrete example of the mobile device 6 is a personal computer, a mobile phone, a portable game machine, a portable information terminal, an information home appliance, a car navigation system, or the like.

As shown in FIG. 14, the mobile device 6 includes power consuming parts 60, a green power generation apparatus 61, an electric storage apparatus 62, an interface apparatus 63, and a value information acquisition unit 64. On the other hand, the power reception apparatus 7 includes an electric power receiving unit 71, a signature verification unit 72, and a value information issuance unit 73.

The power consuming parts 60 are electric parts for realizing each functions of the mobile device 6. The green power generation apparatus 61 has substantially the same function as the green power generation apparatus 11 according to the above first embodiment. The green power generation apparatus 61 is, however, applied with an object small enough to be able to mount on the mobile device 6.

The electric storage apparatus 62 is, similar to the green power generation apparatus 61, applied with an object enough to be able to mount on the mobile device 6. Moreover, the electric storage apparatus 62 may, different from the electric storage apparatus 12 according to the above first embodiment, omit an issuance method of the certificate of electric-storage. In this case, a certificate of electric-generation will be utilized instead of the certificate of electric-storage. Note that omitting the function to issue the certificate of electric-storage contributes to make the mobile device 6 smaller and much more power-saving.

The interface apparatus 63 is an operation method to receive a user's operation, and a method for displaying information for the user. The value information acquisition unit 64 acquires value information from the power reception apparatus 7. This value information is, for example, a coupon or electric money, or the like. Note that the communication between the mobile device 6 and the power reception apparatus 7 may be wired or wireless. The power transmission between the mobile device 6 and the power reception apparatus 7 may be in a non-contact manner using electromagnetic induction, or in a wired manner using power lines.

When the user operation instructs to transmit electricity from the electric storage apparatus 62 to the power reception apparatus 7, the electricity discharged from the electric storage apparatus 62 is to be received by the electric power receiving unit 71 of the power reception apparatus 7. At this time, the certificate of electric-generation that has been issued by the green power generation apparatus 61 is transmitted to the power reception apparatus 7 via the interface apparatus 63. This certificate of electric-generation is to be received by the signature verification unit 72 of the power reception apparatus 7. The signature verification unit 72 that has received the certificate of electric-generation acquires a public key certificate of the green power generation apparatus 61 from the certificate authority 4, and verifies a digital signature contained in the acquired certificate of electric-generation using a public key contained in the acquired public key certificate.

If succeeded in the verification, the signature verification unit 72 outputs the certificate of electric-generation externally as well as inputs information on the electric-generation capacity contained in the certificate of electric-generation into the value information issuance unit 73. The value information issuance unit 73 to which the information on the electric-generation capacity has been input transmits the value information corresponding to the electric-generation capacity to the mobile device 6 based on the information on the electric-generation capacity that has been input. The value information transmitted by the mobile device 6 is to be received by the value information acquisition unit 64 of the mobile device 6, and to be input into the interface apparatus 63. The interface apparatus 63 stores the value information that has been input by the value information acquisition unit 64.

The configuration of the mobile device 6 and the power reception apparatus 7 according to the present embodiment has been explained as above.

(3-2: Configuration of Green Power Generation Apparatus 61)

With reference to FIG. 15 and FIG. 16, an explanation will be given on configuration of a green power generation apparatus 61 according to the present embodiment. FIG. 15 is an explanatory diagram for illustrating a functional configuration of the green power generation apparatus 61 according to the present embodiment. FIG. 16 is an explanatory diagram for illustrating a functional configuration of a certificate of electric-generation issuance unit 614 according to the present embodiment.

(Overall Configuration)

As shown in FIG. 15, the green power generation apparatus 61 includes a photovoltaic panel 611, an electric-generation capacity measurement unit 612, an electric power transmission unit 613, a certificate of electric-storage 614, and a communication unit 615. Note that in the following description, the electric-generation capacity measurement unit 612 and the certificate of electric-generation issuance unit 614 may be collectively called a certificate module.

The photovoltaic panel 611 is a method of generating power for converting the energy of solar light into electricity. The photovoltaic panel 611 utilizes, for example, silicon solar cells or dye-sensitised solar cells or the like. The electricity generated by the photovoltaic panel 611 is to be input into the electric-generation capacity measurement unit 612. The electric-generation capacity measurement unit 612 measures the electric-generation capacity of the photovoltaic panel 611. Information on the electric-generation capacity measured by the electric-generation capacity measurement unit 612 is to be input into the certificate of electric-generation issuance unit 614.

The electricity generated by the photovoltaic panel 611 is to be input into the electric power transmission unit 613 via the electric-generation capacity measurement unit 612. The electric power transmission unit 613 to which the electricity generated by the photovoltaic panel 611 is input transmits the input electricity to the power consuming parts 60 or the electric storage apparatus 62. Note that in this description herein, the electricity input by the electric power transmission unit 613 is to be transmitted to the electric storage apparatus 62.

The certificate of electric-generation issuance unit 614 to which the information on the electric-generation capacity has been input from the electric-generation capacity measurement unit 612 issues a certificate of electric-generation to the input information on the electric-generation capacity. Note that the detail functional configuration of the certificate of electric-generation issuance unit 614 will be described later. The certificate of electric-generation that has been issued by the certificate of electric-generation issuance unit 614 is to be input into the communication unit 615. The communication unit 615 to which the certificate of electric-generation has been input transmits the input certificate of electric-generation to the interface apparatus 63.

(Details of the Certificate of Electric-Generation Issuance Unit 614)

An explanation will be given on the detail functional configuration of the certificate of electric-generation issuance unit 614. As shown in FIG. 16, the certificate of electric-generation issuance unit 614 is configured from a signature generation unit 6141, a storage unit 6142, and a certificate generation unit 6143. Note that the storage unit 6142 stores a pair of a secret key and a public key which have been generated in advance. Further, the public key stored in the storage unit 6142 is assumed to have been certified by the certificate authority 4.

In the event when the information on the electric-generation capacity is input from the electric-generation capacity measurement unit 612 to the certificate of electric-generation issuance unit 614, the input information on the electric-generation capacity is to be input into the signature generation unit 6141. The signature generation unit 6141 to which the information on the electric-generation capacity has been input reads a secret key from the storage unit 6142, and generates a digital signature based on the information on the electric-generation capacity using the secret key that has been read. The digital signature generated by the signature generation unit 6141 is to be input into the certificate generation unit 6143 along with the information on the electric-generation capacity. The certificate generation unit 6143 to which the digital signature and the information on the electric-generation capacity have been input generates a certificate of electric-generation contained the digital signature and the information on the electric-generation capacity which have been input. Subsequently, the certificate of electric-generation generated by the certificate generation unit 6143 is to be input into the communication unit 615.

The configuration of the green power generation apparatus 61 according to the present embodiment has been explained as above.

(3-3: Configuration of Electric Storage Apparatus 62)

With reference to FIG. 17, the configuration of the electric storage apparatus 62 according to the present embodiment will be explained. FIG. 17 is an explanatory diagram for illustrating a functional configuration of the electric storage apparatus 62 according to the present embodiment.

(Overall Configuration)

As shown in FIG. 17, the electric storage apparatus 62 includes an electric power receiving unit 621, a charge/discharge control unit 622, a battery 623, and an electric power transmission unit 624.

(At Receiving)

At first, the electricity supplied by the green power generation apparatus 61 is to be received by the electric power receiving unit 621. The electricity received by the electric power receiving unit 621 is to be input into the charge/discharge control unit 622. The charge/discharge control unit 622 to which the electricity has been input by the electric power receiving unit 621 inputs the input electricity to the battery 623 so as to recharge the battery 623.

(At Transmitting)

If the battery 623 receives an instruction to discharge via the interface apparatus 63, the instruction is to be input into the charge/discharge control unit 622. The charge/discharge control unit 622 to which the instruction for discharging has been input discharges the amount of electricity based on the instruction from the battery 623. The electricity that has been discharged from the battery by the charge/discharge control unit 622 is to be input into the electric power transmission unit 624, and is to be transmitted to the power consuming parts 60 or the power reception apparatus 7 from the electric power transmission unit 624. In this example, however, it is assumed to be transmitted to the power reception apparatus 7.

The configuration of the electric storage apparatus 62 according to the present embodiment has been explained as above.

(3-4: Configuration of Interface Apparatus 63)

With reference to FIG. 18, the configuration of the interface apparatus 63 according to the present embodiment will be explained. FIG. 18 is an explanatory diagram for illustrating a functional configuration of the interface apparatus 63 according to the present embodiment.

As shown in FIG. 18, the interface apparatus 63 includes a communication unit 631, a central processing unit 632, a storage unit 633, a display unit 634 and an input unit 635.

When the electricity is discharged from the electric storage apparatus 62, a user inputs information on the amount of discharged electricity or the like using the input unit 635. The information that has been input using the input unit 635 is to be input into the electric storage apparatus 62 via the central processing unit 632 and the communication unit 631. When the process of discharging electricity is performed by the electric storage apparatus 62, the communication unit 631 receives a certificate of electric-generation from the green power generation apparatus 61. The certificate of electric-generation received by the communication unit 631 is to be input into the central processing unit 632. The central processing unit 632 to which the certificate of electric-generation has been input transmits the input certificate of electric-generation to the power reception apparatus 7 via the communication unit 631.

Further, when the user input an instruction to discharge using the input unit 635, the central processing unit 632 transmits an instruction of discharging and information on the amount of discharged electricity to the electric storage apparatus 62 via the communication unit 631. Note that the storage unit 633 is used to store value information received from the power reception apparatus 7, or information that a user has input, or is used to store a public key or the like of the green power generation apparatus 61 as needed. The storage unit 633 is used to store a program that defines operations of the central processing unit 632.

The configuration of the interface apparatus 63 according to the present embodiment has been explained as above.

(3-5: Operation for Transmitting Electric Power)

Next, with reference to FIG. 19 and FIG. 20, the operation method at the time of transmitting electric power will be explained. FIG. 19 is an explanatory diagram for illustrating a flow of operation for transmitting electric power according to the present embodiment. FIG. 20 is an explanatory diagram for illustrating an example of a graphical interface to be displayed in the flow of operation for transmitting electric power according to the present embodiment.

As shown in FIG. 19, the mobile device 6 and the power reception apparatus 7 execute a mutual authentication (S101). If succeeded in the mutual authentication, the mobile device 6 notifies the power reception apparatus 7 of the maximum amount of electric power transmission (S102). This maximum amount of electric power transmission is remaining battery level of the battery 623, remaining level which is calculated by subtracting a certain margin necessary for the operation of the mobile device 6 from the remaining battery level, or the maximum value of the amount of power transmission which has been input by a user. The power reception apparatus 7 encourages the user to select the amount of power transmission and allows the user to select the amount of power transmission (S103), as shown in FIG. 20.

If the electric-generation capacity has been selected by the user, the power reception apparatus 7 notifies the electric-generation capacity selected by the user, and requests for assignment of a certificate of electric-generation as well (S104). Subsequently, the mobile device 6 encourages the user to select whether to allow power transmission, as shown in FIG. 2 (S105). If the user allows the power transmission, the mobile device 6 starts to transmit electricity, and transmits (assigns) the certificate of electric-generation to the power reception apparatus 7 as well (S106). Note that granting value information will be done after the step S106 in accordance with the electric-generation capacity that is certified by the certificate of electric-generation.

The operation method at the time of transmitting electric power according to the present embodiment has been explained as above.

### 4: Example of Hardware Configuration

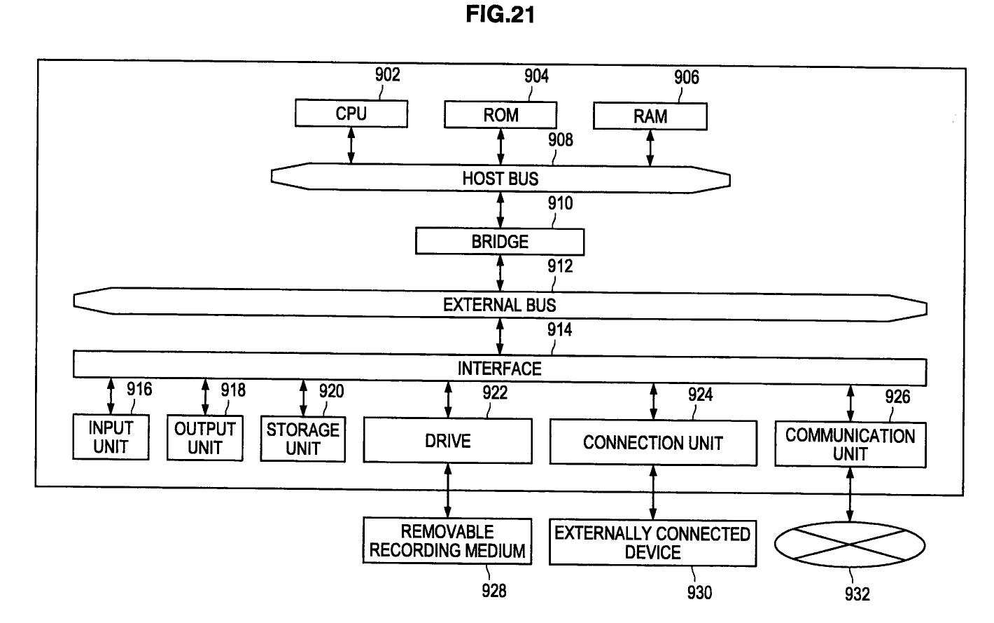

The functions of the various types of certificate issuance unit, the interface apparatus, the mobile device, the power trade server, or the like described above can be realized by using the hardware configuration of an information processing apparatus shown in FIG. 21, for example. That is, the function of each structural element is realized by controlling the hardware shown in FIG. 21 by using a computer program. Additionally, the mode of this hardware is arbitrary, and may be a personal computer, a mobile information terminal such as a mobile phone, a PHS or a PDA, a game machine, or various types of information appliances. Moreover, the PHS is an abbreviation for Personal Handy-phone System. Also, the PDA is an abbreviation for Personal Digital Assistant.

As shown in FIG. 21, this hardware mainly includes a CPU 902, a ROM 904, a RAM 906, a host bus 908, and a bridge 910. Furthermore, this hardware includes an external bus 912, an interface 914, an input unit 916, an output unit 918, a storage unit 920, a drive 922, a connection port 924, and a communication unit 926. Moreover, the CPU is an abbreviation for Central Processing Unit. Also, the ROM is an abbreviation for Read Only Memory. Furthermore, the RAM is an abbreviation for Random Access Memory.

The CPU 902 functions as an arithmetic processing unit or a control unit, for example, and controls an entire operation or a part of the operation of each structural element based on various programs recorded on the ROM 904, the RAM 906, the storage unit 920, or a removable recording medium 928. The ROM 904 is means for storing, for example, a program to be loaded on the CPU 902 or data or the like used in an arithmetic operation. The RAM 906 temporarily or perpetually stores, for example, a program to be loaded on the CPU 902 or various parameters or the like arbitrarily changed in execution of the program.

These structural elements are connected to each other by, for example, the host bus 908 capable of performing high-speed data transmission. For its part, the host bus 908 is connected through the bridge 910 to the external bus 912 whose data transmission speed is relatively low, for example. Furthermore, the input unit 916 is, for example, a mouse, a keyboard, a touch panel, a button, a switch, or a lever. Also, the input unit 916 may be a remote control that can transmit a control signal by using an infrared ray or other radio waves.

The output unit 918 is, for example, a display device such as a CRT, an LCD, a PDP or an ELD, an audio output device such as a speaker or headphones, a printer, a mobile phone, or a facsimile, that can visually or auditorily notify a user of acquired information. Moreover, the CRT is an abbreviation for Cathode Ray Tube. The LCD is an abbreviation for Liquid Crystal Display. The PDP is an abbreviation for Plasma Display Panel. Also, the ELD is an abbreviation for Electro-Luminescence Display.

The storage unit 920 is a device for storing various data. The storage unit 920 is, for example, a magnetic storage device such as a hard disk drive (HDD), a semiconductor storage device, an optical storage device, or a magneto-optical storage device. The HDD is an abbreviation for Hard Disk Drive.

The drive 922 is a device that reads information recorded on the removal recording medium 928 such as a magnetic disk, an optical disk, a magneto-optical disk, or a semiconductor memory, or writes information in the removal recording medium 928. The removal recording medium 928 is, for example, a DVD medium, a Blu-ray medium, an HD-DVD medium, various types of semiconductor storage media, or the like. Of course, the removal recording medium 928 may be, for example, an IC card on which a non-contact IC chip is mounted or an electronic device. The IC is an abbreviation for Integrated Circuit.

The connection port 924 is a port such as an USB port, an IEEE1394 port, a SCSI, an RS-232C port, or a port for connecting an externally connected device 930 such as an optical audio terminal. The externally connected device 930 is, for example, a printer, a mobile music player, a digital camera, a digital video camera, or an IC recorder. Moreover, the USB is an abbreviation for Universal Serial Bus. Also, the SCSI is an abbreviation for Small Computer System Interface.

The communication unit 926 is a communication device to be connected to a network 932, and is, for example, a communication card for a wired or wireless LAN, Bluetooth (registered trademark), or WUSB, an optical communication router, an ADSL router, or various communication modems. The network 932 connected to the communication unit 926 is configured from a wire-connected or wirelessly connected network, and is the Internet, a home-use LAN, infrared communication, visible light communication, broadcasting, or satellite communication, for example. Moreover, the LAN is an abbreviation for Local Area Network. Also, the WUSB is an abbreviation for Wireless USB. Furthermore, the ADSL is an abbreviation for Asymmetric Digital Subscriber Line.

The example of a hardware configuration capable of realizing functions of the interface apparatus, the mobile device, the power trade server, or the like according to the present embodiment has been explained as above.

### 5: Conclusion

Lastly, the technical contents according to the embodiments of the present invention will be briefly described. The power trade server according to the present embodiment can be described as follows; the power trade server includes a first certificate acquisition unit, a second certificate acquisition unit, a power selling limitation unit, and a power purchase limitation unit as follows.

The above first certificate acquisition unit is to obtain, from a first user who wants to sell electricity, a first certificate to certify an amount of stored electricity of a first battery owned by the first user. Using the first certificate enables remaining battery level of user's battery to be confirmed surely and in real-time.

Further, a second certificate acquisition unit is to obtain, from a second user who wants to buy electricity, a second certificate to certify an amount of space of a second battery owned by the second user. Using the second certificate enables amount of space of user's battery to be confirmed surely and in real-time.

Further, the above power selling limitation unit is to limit the amount of electricity the first user can sell to the amount of stored electricity of the first battery based on the first certificate obtained by the first certificate acquisition unit. In this way, by limiting power selling based on the first certificate, it can avoid a risk that the delivery and receipt of cash commodities will be difficult after selling electricity.

Further, the above power purchase limitation unit is to limit the amount of electricity the second user can sell to the amount of space of the second battery based on the second certificate obtained by the second certificate acquisition unit. In this way, by limiting power selling based on the second certificate, it can avoid a risk that the delivery and receipt of cash commodities will be difficult after purchasing electricity.

A preferred embodiment of the present invention has been explained in detail above with reference to the attached drawings, the present invention is not limited to this example. It should be understood by those skilled in the art that various modifications, combinations, sub-combinations and alterations may occur depending on design requirements and other factors insofar as they are within the scope of the appended claims or the equivalents thereof.

Photovoltaic generation has been described as an example of green electric power generation in the above explanation, however, the technology according to the present embodiment can be applied to various types of generations, such as wind power generation, geothermal power generation, hydropower generation, atomic power generation, biomass power generation, natural gas generation, fuel cell generation, and the like. A battery has been described as an example of method of charging electric power. Specifically, the technology according to the present embodiment can be applied in same way to various method of charging electric power, such as a secondary battery (Li-Ion battery, NaS battery, or the like), a capacitor (an electric double-layer capacitor, or the like), a lift storage system, or the like.

The above explanation has excluded a case where a user may be impossible to supply the electricity to sell specified by a buy order at a time of delivery and receipt of the electricity, and a method of trade-off in a case where the user may be impossible to receive the electricity specified by a sell order at a time of delivery and receipt of the electricity. Such cases may be occurred, for example, when a user who is going to sell places a sell order of the amount of the electricity added with the amount of electricity that the user has estimated to be generated by a method of generating power by the time of delivery and receipt. Further, it may be occurred when a user who is going to buy places a buy order of the amount of the electricity added with the amount of electricity that the user has estimated to be consumed by a method of storage power by the time of delivery and receipt.

In other words, if the actual electric-generation capacity or the amount of electricity consumption is below than the expectation, the delivery and receipt of the electricity may be impossible to be done at the time of the delivery and receipt. If such a case occurs, trade-off should be done regarding the amount of electricity not to be dealt with. For example, it is necessary to instruct the user to do a net settlement. It is preferable, however, that price for trade-off includes a certain amount of penalty, in order to minimize the occurrence of such cases.

For such reasons, the power trade server may be arranged with a system of trade-off as well as power selling limitation and power purchase limitation. Moreover, the above expected electric-generation capacity may be configured so as to be certified by the first certificate. Further, the above estimated amount of consumption may be configured so as to be certified by the second certificate. By making such configurations, it is possible to perform a flexible power trade safely and soundly with consideration for the expected electric-generation capacity, and the expected amount of consumption.

The present application contains subject matter related to that disclosed in Japanese Priority Patent Application JP 2010-040463 filed in the Japan Patent Office on Feb. 25, 2010, the entire content of which is hereby incorporated by reference.

What is claimed is:

1. A power trade server comprising:
a first certificate acquisition unit for obtaining a first certificate from a first user who wants to sell electricity, the first certificate being for certifying an amount of stored electricity of a first device for charging electricity owned by the first user;
a second certificate acquisition unit for obtaining a second certificate from a second user who wants to buy electricity, the second certificate being for certifying an amount of space of a second device for charging electricity owned by the second user;
a power selling limitation unit for limiting an amount of electricity the first user can sell up to the amount of stored electricity of the first device for charging electricity based on the first certificate obtained by the first certificate acquisition unit; and
a power purchase limitation unit for limiting an amount of electricity the second user can buy up to the amount of space of the second device for charging electricity based on the second certificate obtained by the second certificate acquisition unit.

2. The power trade server according to claim 1, wherein
when the first user owns a device for generating electricity, the first certificate acquisition unit obtains a first certificate for certifying the amount of stored electricity of the first device for charging electricity, and an expected electric-generation capacity which is predicted from an actual electric-generation capacity by the device for generating electricity, and
the power selling limitation unit limits the amount of electricity the first user can sell up to a first total value of the amount of stored electricity of the first device for charging electricity and the expected electric-generation capacity of the device for generating electricity based on the first certificate obtained by the first certificate acquisition unit.

3. The power trade server according to claim 2, wherein
when the first user places a sell order to sell the first total value of the amount of electricity while being unable to supply the first total value of the amount of electricity at the time of power supply, the power selling limitation unit allows the first user to repurchase the amount of electricity at a surcharge price.

4. The power trade server according to claim 2, wherein
when the second user manages history of an amount of electricity consumed by the second device for charging electricity, the second certificate acquisition unit obtains a second certificate for certifying the amount of space of the second device for charging electricity owned by the second user, and an expected amount of consumption predicted by an actual consumption of the amount of electricity consumed by the second device for charging electricity, and
the power purchase limitation unit limits the amount of electricity the second user can buy up to a second total value of the amount of space and the expected amount of consumption of the second device for charging electricity based on the second certificate obtained by the second certificate acquisition unit.

5. The power trade server according to claim 4, wherein
when the second user places a buy order to purchase the second total value of the amount of electricity while being unable to receive the second total value of the amount of electricity at the time of power supply, the power purchase limitation unit allows the second user to sell back the amount of electricity at a surcharge price.

6. The power trade server according to claim 4 further comprising:
a green certificate acquisition unit for obtaining a green certificate for certifying that electricity to be traded is green power generated by renewable energy or environmentally friendly resources; and
a green price setting unit for setting a buying price of the green power that is different from a general buying price of electricity the first user wants to buy when the green certificate acquisition unit obtains a green certificate of the electricity the first user wants to buy.

7. The power trade server according to claim 6 further comprising:
an order reception unit for receiving sell orders and buy orders of electricity;
a market price decision unit for determining a selling price and a buying price in a power trading market depending on a balance of supply and demand based on an amount of the sell orders and the buy orders that the order reception unit has received; and
a supply control unit for supplying an amount of electricity ordered by the first user from the first device for charging electricity to a certain electric storage apparatus when the first user has closed the selling trade, and for supplying the amount of electricity ordered by the second user from the certain electric storage apparatus to the second device for charging electricity when the second user has closed the buying trade.

8. The power trade server according to claim 7, wherein
the order reception unit limits reception of orders not to receive orders successively from the same user in a certain period of time.

9. The power trade server according to claim 8, wherein
when the first user has closed the selling trade, the supply control unit supplies an amount of electricity ordered by the first user from the first device for charging electricity to a certain electric storage apparatus after a certain period of time has elapsed since the closing of the trade, and when the second user has closed the buying trade, the supply control unit supplies an amount of electricity ordered by the second user from the certain electric storage apparatus to the second device for charging electricity after a certain period of time has elapsed since the closing of the trade.

10. The power trade server according to claim 7, further comprising
a local market price collection unit for separating a small trading market into small communities where power is actually to be traded therebetween, and for obtaining a selling price and a buying price in each small trading market from a plurality of the small trading market separated into the small communities,
wherein the market price decision unit decides a selling price and a buying price in a large-scale trading market in a large community, that has been set larger than the small communities, based the selling price and the buying price in the plurality of the small trading market obtained by the local market price collection unit.

11. The power trade server according to claim 7, further comprising
a market price forecasting unit for forecasting changes in future buying prices and selling prices based on at least one or a plurality of elements selected from changes in buying prices and selling prices decided by the market price decision unit in the past, changes in amount of selling orders and buying orders received by the order reception unit in the past, information on occurrence factor of renewable energy in the past or at present, and prediction information on occurrence factor of renewable energy in future.

12. A green market management server, comprising:
an order reception unit for receiving a sell order and a buy order regarding a green certificate issued for power that is generated by renewable energy or environmentally friendly resources, the green certificate being for certifying an electric-generation capacity of the power and for certifying that the power is based on renewable energy or environmentally friendly resources; and
a market price decision unit for determining a selling price and a buying price of the green certificate depending on balance of supply and demand based on an amount of the sell orders and the buy orders that the order reception unit has received.

13. A trading management method
wherein a power trade server comprises the steps of:
obtaining a first certificate from a first user who wants to buy electricity, the first certificate being for certifying an amount of stored electricity of a first device for charging electricity owned by the first user; and
obtaining a second certificate from a second user who wants to sell electricity, the second certificate being for certifying an amount of space of a second device for charging electricity owned by the second user;
limiting an amount of electricity the first user can sell up to the amount of stored electricity of the first device for charging electricity based on the first certificate obtained by the step of obtaining the first certificate; and
limiting an amount of electricity the second user can buy up to the amount of space of the second device for charging electricity based on the second certificate obtained by the step of obtaining the second certificate.

14. A green trading management method comprising the steps of
receiving a sell order and a buy order regarding a green certificate issued for power that is generated by renewable energy or environmentally friendly resources, the green certificate being for certifying an electric-generation capacity of the power and for certifying that the power is based on renewable energy or environmentally friendly resources; and
determining a selling price and a buying price of the green certificate depending on a balance of supply and demand based on an amount of the sell orders and the buy orders received in the step of receiving.
